(19) United States
(12) Patent Application Publication
(10) Pub. No.: US 2012/0258296 A1
(43) Pub. Date: Oct. 11, 2012

(54) OPTICAL FILM, POLARIZING PLATE, METHOD FOR PRODUCING OPTICAL FILM, METHOD FOR PRODUCING POLARIZING PLATE, IMAGE DISPLAY DEVICE, AND IMAGE DISPLAY SYSTEM

(75) Inventor: Shigeaki Nimura, Kanagawa (JP)

(73) Assignee: FUJIFILM CORPORATION, Tokyo (JP)

(21) Appl. No.: 13/518,652

(22) PCT Filed: Dec. 24, 2010
(86) PCT No.: PCT/JP2010/073275

§ 371 Date: Jun. 22, 2012

(30) Foreign Application Priority Data
Dec. 25, 2009 (JP) 2009-295823

(51) Int. Cl. B32B 7/02; C08B 3/06; G02B 5/30

(52) U.S. Cl. 428/212; 264/1.24; 264/1.27; 156/199; 359/489.07; 536/69

(57) ABSTRACT

An optical film formed of a cellulose acylate and having a first region and a second region that differ from each other in the birefringence, wherein the angle between the slow axis of the first region and the slow axis of the second region is at least 45 degrees can be produced at a low cost and used for 3D stereoscopic image display.

### TECHNICAL FIELD

The present invention relates to an optical film, a polarizer, a method for producing an optical film, a method for producing a polarizer, an image display device, and an image display system. More precisely, the invention relates to an image display panel and an image display system for 2D-3D combined application for displaying both a stereoscopic image and a two-dimensional image, and to a patterned retardation film for use in the image display panel.

### BACKGROUND ART

In the field of 3D stereoscopic image display in which the projected image can be stereoscopically seen as if it could fly out so that the viewers could enjoy a dynamic view of the projected scene, recently, 3D movies have become rapidly popularized; and with that, 3D stereoscopic image display on a flat panel display device in a more accessible situation has come to receive a fair amount of attention. Heretofore, there are known various systems of stereoscopically viewing 3D images with naked eyes, and various systems of stereoscopically viewing them through special glasses. From the viewpoint that one can see images while moving in daily life different from the case where one appreciates 3D movies in a theater while sitting down therein, a system of using special glasses is specifically noted.

On the other hand, at present, 3D image contents for flat panel displays are not satisfactory as yet. Therefore, an image display system is desired, which realizes easy switching between 2D display and 3D display and which exhibits 2D image and 3D image both of high quality. As a system of satisfying these requirements, two of a glasses shutter system (active glasses system) and a polarized glasses system (passive glasses system) are specifically noted. In the field of flat panel display in which high picture quality technology has been advanced recently, it is in fact considered that only these two systems could keep high image quality in ordinary flat panel display and could provide high-definition 3D stereoscopic images; and among these, it is desired to further improve the polarized glasses system from the viewpoint that the system is relatively inexpensive and could be widely popularized.

In the polarized glasses system, a left eye image and a right eye image are displayed on the panel, then the left eye image light and the right eye image light emitted from the display are individually made in two different polarized states (for example, in right circular polarization and left circular polarization), and via polarized glasses that comprise a right circular polarized light transmitting polarizer and a left circular polarized light transmitting polarizer, a viewer looks at the display to see the intended stereoscopic image thereon (see Patent Reference 1). As a method of displaying the left eye image and the right eye image on the display panel in the polarized glasses system, there is employed a screen splitting system where a half of the original image for each of the left eye image and the right eye image is displayed individually on a half of the display panel. As the screen splitting system, widely employed is a line-by-line system in which a half of the left eye image for which the number of the pixels is halved so as to be at every other line of the original image for the left eye, and a half of the right eye image for which the number of the pixels is halved so as to be at every other line of the original image for the right eye are displayed in the odd-numbered lines and the even-numbered lines, respectively, of the scanning lines of the display (the scanning lines are referred to as lines). As the method of making the left eye image light and the right eye image light emitted from the display panel in two different polarized states, widely employed is a method of sticking a patterned retardation film, in which different retardations are repeatedly belt-wise patterned and aligned in accordance with the line width, onto the display panel.

Recently, the patterned retardation film of the type, in which different retardations are repeatedly belt-wise patterned and aligned in accordance with the line width of the image display device, is desired to be further improved and its production cost reduction is desired for further popularization of 3D image display devices.

Various methods are known for producing such a patterned retardation film (see Patent References 1 to 5).

Patent Reference 1 discloses a production method, in which a polarizing film prepared by laminating an unstretched cellulose triacetate (hereinafter referred to as TAC) film not having birefringence and an iodine-processed stretched polyvinyl alcohol (hereinafter referred to as PVA) film having a retardation function is used, the polarizing film is coated with a photoresist, a specific region of the PVA film having a retardation function is exposed to light and thereafter processed with a potassium hydroxide solution to thereby erase the retardation function in a part of the region of the film.

Patent Reference 2 discloses a production method, in which a polarizing film prepared by laminating an unstretched TAC film not having birefringence and an iodine-processed stretched PVA film is used similarly, a resist member is provided in a specific region on the PVA side of the polarizing film and then dipped in hot water to thereby erase the retardation function in a part of the region of the film.

Patent Reference 3 discloses a method in which two polymer films having a retardation of 140 nm are used. Examples in the patent reference disclose a method, in which a polysulfone film as a first retardation film is laminated on the substrate, a resist is provided on a part, of the region of the polysulfone film, the film is then etched to form a part of a pattern, then a polystyrene film as the second retardation film is arranged in such a manner that it could cover the substrate and the patterned polysulfone film and that the slow axes of the first and second retardation films could be perpendicular to each other, then a resist is provided only on the part that covers the substrate and etched thereby producing an optical film having two different birefringence regions derived from the two polymer films on the substrate. In [0043] of the patent reference, described is use of other polymer films having birefringence of polycarbonate, polysulfone, polyarylate, polyether sulfone, polyether ether ketone, etc.

Patent Reference 4 discloses a production method, in which the chemical etching treatment as in Patent Reference 3 is changed into physical cutting treatment with a dicer. In [0079] of Patent Reference 4, there are mentioned an H-polarizing film prepared by incorporating iodine, dichoric dye, pigment or the like into a monostretched film, a K-polarizing film such as a monostretched polyvinylene film or the like, a film prepared by incorporating dichoric dye into a monoaligned polymer liquid-crystal film, etc., as retardation film materials.

Patent Reference 5 discloses a method of using a retardation film that contains a photochromic compound having a photoisomerizing functional group (photoisomerization substance) and a polymer capable of interacting with the compound. In Examples in the patent reference, a pretreated sheet that contains polyethylene terephthalate and a photoisomerization substance is covered with a photomask in which the light-transmitting part and the light-non-transmitting part are patterned in a desired form and with a polarizer for obtaining linear polarization both put thereon, then first this is exposed to UV light having a wavelength corresponding to the photoisomerization substance from the top thereof as the first exposure to thereby make the polymer in the part of the retardation film through which the UV ray has passed is aligned in the transmission axis direction. Next, the photomask is moved so that the configuration of the light-transmitting part and the light-non-transmitting part could be contrary to that in the former first case and the transmission axis of the polarizer is rotated by 90 degrees, then the second time, this is again exposed to UV rays whereby the polymers in the retardation film through which the UV ray did not pass in the previous exposure is aligned in the transmission axis direction of the polarizer rotated by 90 degrees as compared with that in the former first case. The patent reference describes polymers produced through polycondensation of hydroxycarboxylic acid, aromatic carboxylic acid, aromatic diol and the like, and also poly(meth)acrylic acid copolymers, as examples of the polymer to be used, therefore indicating that the polymer includes polymerizing resins.

### CITATION LIST

### Patent References

Patent Reference 1: U.S. Pat. No. 5,327,285
Patent Reference 2: JP-A 2001-59949
Patent Reference 3: JP-A 10-161108
Patent Reference 4: JP-A 10-160933
Patent Reference 5: JP-A 10-153707

### SUMMARY OF THE INVENTION

### Problems that the Invention is to Solve

The present inventors investigated Patent References 1 to 5 and have known that heretofore no one knows a patterned retardation film of a cellulose acylate and its production method, including the descriptions in these patent references and the contents suggested therein. In particular, Patent References 1 and 2 describe a production method for a patterned retardation film, using a laminate of a cellulose acylate-type TAC film and a PVA film, in which, however, the TAC film is used as a protective film (support) not having birefringence and for treatment of the film for birefringence expression and for birefringence erasure in a part of the birefringence expression-treated part is applied to only the surface of the PVA film. Needless-to-say, therefore, these patent publications do neither disclose nor suggest a method and a technical idea of erasing the birefringence in a part of a TAC film used as the protective film, and further, do neither disclose nor suggest even a technical idea of making the TAC film itself express birefringence.

The method described in Patent References 3 to 5, in which two materials each having a different birefringence are arranged so that the slow axes thereof could deviate from each other, for example, by 90 degrees, and, after patterned, the unnecessary part is removed by etching or physically cutting, is still unsatisfactory in that the material cost is high and the production process is complicated.

Further, the present inventors have known that the methods described in Patent References 1 to 5 are all unsuitable or insufficient for continuously producing a patterned retardation film, and further reduction in the production cost is desired.

Accordingly, patterned retardation films with multiple regions differing in the birefringence, which have heretofore been known, are unsatisfactory in point of the production cost.

Given the situation, an object of the present invention is to solve these problems. Specifically, the object of the invention is to provide an optical film with multiple regions differing in the birefringence, which is formed of a cellulose acylate and of which the production cost is low.

### Means for Solving the Problems

The inventors have assiduously studied for the purpose of solving the above-mentioned problems and, as a result, have found that, when a partial region of a stretched film of a cellulose acylate is specifically heated, then only the retardation expression direction of the film can be significantly varied while the level of the absolute value of the retardation in the heated region of the film can be kept as such, and in addition, the level of the absolute value of the retardation in the non-heated region thereof and also the expression direction can be kept as such. Based on these findings, the inventors have reached the present invention.

Specifically, the inventors have found that the above-mentioned problems can be solved by the following contexture.

[1] An optical film formed of a cellulose acylate and having a first region and a second region that differ from each other in the birefringence, wherein the angle between the slow axis of the first region and the slow axis of the second region is at least 45 degrees.

[2] The optical film of [1], wherein the composition of the first region is the same as that of the second region.

[3] The optical film of [1] or [2], which is a single-layer film.

[4] The optical film of any one of [1] to [3], wherein the total degree of acyl substitution of the cellulose acylate is from 2.7 to 3.0.

[5] The optical film of any one of [1] to [4], wherein the slow axis of the first region is perpendicular to the slow axis of the second region.

[6] The optical film of any one of [1] to [5], wherein the Re value of all the first region contained in the optical film and the Re value of all the second region contained in the optical film are from 30 to 250 nm (in this, Re means the retardation value in the in-plane direction of the film).

[7] The optical film of any one of [1] to [6], wherein the alignment direction of the polymer constituting the first region is substantially the same as the alignment direction of the polymer constituting the second region.

[8] The optical film of any one of [1] to [7], wherein the first region and the second region are stripe ones, and the angle between the long-side direction of the stripe regions and the alignment directions that are substantially the same directions of the polymers constituting the first region and the second region is around 45 degrees.

[9] The optical film of any one of [1] to [8], which contains a compound having a positive intrinsic birefringence.

[10] The optical film of any one of [1] to [9], which contains a compound having IR absorption capability.

[11] The optical film of any one of [1] to [10], wherein the first region and the second region are stripe ones, of which the length of the short side is nearly equal to each other, and are patterned alternately repeatedly.

[12] The optical film of any one of [1] to [11], wherein the boundary between the first region and the second region does not contain an adhesive or a bond.

[12-2] The optical film of any one of [1] to [12], wherein in the boundary between the first region and the second region, the angle between the slow axis of the first region and the slow axis of the second region or the absolute value of Re continuously varies.

[13] A method for producing an optical film, comprising stretching the entire film containing a cellulose acylate in a specific direction and heating a partial region of the stretched film in such a manner that the slow axis formed by the stretching in the partial region could rotate by at least 45 degrees.

[14] The method for producing an optical film of [13], wherein the stretching direction is the film traveling direction.

[15] The method for producing an optical film of [13], wherein the stretching direction is a direction oblique to the film traveling direction by about 45 degrees.

[16] The method for producing an optical film of any one of [13] to [15], wherein the partial region is heated by irradiation with an IR laser.

[17] The method for producing an optical film of any one of [13] to [16], wherein the partial region is heated when the water content in the stretched film is at most 5%.

[18] The method for producing an optical film of any one of [13] to [17], which includes forming the cellulose acylate-containing film in a mode of solution casting.

[19] The method for producing an optical film of [18], wherein the partial region is heated when the stretched film contains the solvent in an amount of at least 3%.

[20] The method for producing an optical film of any one of [13] to [19], wherein the partial region to be heated is a part of the stripe region of the stretched film.

[21] The method for producing an optical film of [20], wherein the partial region is so heated that the long side of the stripe region is at about 45 degrees to the stretching direction.

[22] The method for producing an optical film of [20] or [21], wherein the partial region is heated so as to form at least two stripe regions, thereby forming a first stripe region which has been heated such that the slow axis therein formed by stretching is rotated by at least 45 degrees and a second stripe region which has not been heated such that the slow axis therein formed by stretching is rotated by at least 45 degrees.

[23] The method for producing an optical film of [22], wherein the length of the short side of the first stripe region is nearly the same as the length of the short side of the second stripe region.

[24] An optical film produced according to the production method of any one of [13] to [23].

[25] A polarizer laminated with at least one optical film of any one of [1] to [12] and [24].

[26] An image display panel including at least one optical film of any one of [1] to [12] and [24].

[27] An image display system including at least one optical film of any one of [1] to [12] and [24].

[28] A method for producing a polarizer, comprising stretching the entire film containing a cellulose acylate in a direction oblique to the film traveling direction by about 45 degrees, heating the stretched film in such a manner that the slow axis formed by the stretching could rotate by at least 45 degrees relative to the stripe region of a part of the stretched film of which the long side is in the film conveying direction, thereby forming at least two regions of a first stripe region which has been heated such that the slow axis therein formed by stretching is rotated by at least 45 degrees and a second stripe region which has not been heated such that the slow axis therein formed by stretching is rotated by at least 45 degrees, and laminating the resulting optical film on a long polarizer of which the transmission axis is at the width direction thereof, in a mode of roll-to-roll lamination.

### Advantage of the Invention

According to the invention, there is obtained an optical film having multiple regions each having a different birefringence, which is formed of a cellulose acylate and for which the production cost is low. In addition, the production cost for the production method of the invention is low. The image display panel and the image display system comprising the optical film and the polarizer of the invention are usable for 3D stereoscopic image display.

### BRIEF DESCRIPTION OF THE DRAWINGS

FIG. 1 is a schematic view of the optical film of the invention, which is produced in a case of stretching in the film traveling direction followed by belt-like thermal irradiation in a direction oblique by 45 degrees to the film traveling direction, as one embodiment of the production method of the invention.

FIG. 2 is a schematic view showing a mode of stretching in a direction oblique by 45 degrees to the film traveling direction, in one embodiment of the production method of the invention.

FIG. 3 is a schematic view of the optical film of the invention, which is produced in a case of stretching in a direction oblique by 45 degrees to the film traveling direction followed by belt-like thermal irradiation in the film traveling direction, as one embodiment of the production method of the invention.

FIG. 4 is a schematic view of a corrugated roller for use in heating a partial region of a stretched film, as one embodiment of the production method of the invention.

### MODE FOR CARRYING OUT THE INVENTION

The contents of the invention are described in detail hereinunder. The description of the constitutive elements of the invention given hereinunder is for some typical embodiments of the invention, to which, however, the invention should not be limited. In this description, the numerical range expressed by the wording “a number to another number” means the range that falls between the former number indicating the lower limit of the range and the latter number indicating the upper limit thereof. In this description, the slow axis inversion or the axis inversion means that the slow axis rotates by about 90 degrees relative to the original direction.

### [Optical Film]

The optical film of the invention (hereinafter this may be referred to as the film of the invention) is formed of a cellulose acylate (hereinafter this may be referred to as a cellulose acylate resin), and has a first region and a second region that differ from each other in the birefringence, wherein the angle between the slow axis of the first region and the slow axis of the second region is at least 45 degrees.

The film of the invention is described below.

### <Cellulose Acylate Resin>

The film of the invention is formed of a cellulose acylate. The wording “formed of a cellulose acylate” means that the film comprises a cellulose acylate “as the main ingredient polymer” of the film. In case where the film is formed of a single polymer, the “main ingredient polymer” means the polymer itself; and in case where the film is formed of multiple polymers, the “main ingredient polymer” means the polymer having a highest mass fraction of the constituent polymers.

The cellulose acylate resin for use in the invention is not specifically defined. The starting cellulose for the cellulose acylate includes cotton linter and wood pulp (hardwood pulp, softwood pulp), etc., and any cellulose acylate obtained from any starting cellulose can be used herein. As the case may be, different starting celluloses may be mixed for use herein. The starting cellulose materials are described in detail, for example, in Marusawa & Uda's “Plastic Material Lecture (17), Cellulosic Resin” (by Nikkan Kogyo Shinbun, 1970), and in Hatsumei Kyokai Disclosure Bulletin No. 2001-1745, pp. 7-8; and cellulose materials described in these may be used here.

The cellulose acylate preferably used in the invention is described in detail. The β-1,4-bonding glucose unit to constitute cellulose has a free hydroxyl group at the 2-, 3- and 6-positions. The cellulose acylate is a polymer produced by esterifying a part or all of those hydroxyl groups in cellulose with an acyl group having at least 2 carbon atoms. The degree of acyl substitution means the total of the ratio of esterification of the hydroxyl group in cellulose positioned in the 2-, 3- and 6-positions in the unit therein. In case where the hydroxyl group is 100% esterified at each position, the degree of substitution at that position is 1.

The total degree of acyl substitution, or that is, DS2+DS3+DS6 thereof is preferably from 2.7 to 3.0 from the viewpoint of slow axis inversion, more preferably from 2.8 to 3.0, even more preferably from 2.9 to 3.0. Also preferably, DS6/(DS2+DS3+DS6) is from 0.08 to 0.66, more preferably from 0.15 to 0.60, even more preferably from 0.20 to 0.45. In this, DS2 means the degree of substitution of the 2-positioned hydroxyl group in the glucose unit with an acyl group (hereinafter this may be referred to as “degree of 2-acyl substitution”); DS3 means the degree of substitution of the 3-positioned hydroxyl group with an acyl group (hereinafter referred to as “degree of 3-acyl substitution”); and DS6 means the degree of substitution of the 6-positioned hydroxyl group with an acyl group (hereinafter referred to as “degree of 6-acyl substitution”). DS6/(DS2+DS3+DS6) is a ratio of the degree of 6-acyl substitution to the total degree of acyl substitution, and this may be hereinafter referred to as “proportion of 6-acyl substitution”).

Only one or two or more different types of acyl groups may be used, either singly or as combined, in the film of the invention. Preferably, the film of the invention has an acyl group with from 2 to 4 carbon atoms as the substituent therein. In case where two or more different types of acyl groups are used, preferably, one of them is an acetyl group, and the acyl group having from 2 to 4 carbon atoms is preferably a propionyl group or a butyryl group. When the sum total of the degree of substitution of the 2-positioned, 3-positioned and 6-positioned hydroxyl groups with an acetyl group is called DSA and the sum total of the degree of substitution of the 2-positioned, 3-positioned and 6-positioned hydroxyl groups with a propionyl group or a butyryl group is called DSB, then the value of DSA+DSB is preferably from 2.7 to 3.0. More preferably, the value of DSA+DSB is from 2.7 to 3.0 and the value of DSB is from 0.2 to 1.0. The values DSA and DSB each preferably fall within the above range, as giving a film of which the change in the Re value and the Rth value depending on the ambient humidity could be small.

In short, the cellulose acylate resin for use for the film of the invention is preferably cellulose acetate from the viewpoint of return to nature and environmental load.

Preferably, the substituent at the 6-positioned hydroxyl group accounts for at least 28% of DSB, more preferably the substituent at the 6-positioned hydroxyl group accounts for at least 30%, even more preferably the substituent at the 6-positioned hydroxyl group accounts for at least 31%, still more preferably the substituent at the 6-positioned hydroxyl group accounts for at least 32%. For the film of the type, a solution having a preferred solubility can be produced, and especially in a non-chlorine organic solvent, a good solution for the film can be formed. In addition, a solution having a further lower viscosity and therefore having better filterability can be formed.

Not specifically defined, the acyl group having at least 2 carbon atoms in the cellulose acylate for use in the invention may be an aliphatic group or an aryl group. For example, the ester is an alkylcarbonyl ester, an alkenylcarbonyl ester, an aromatic carbonyl ester or an aromatic alkylcarbonyl ester of cellulose, in which the acyl group may be further substituted. Apart from acetyl group, preferred examples of the acyl group include a propionyl group, a butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, an iso-butanoyl group, a tert-butanoyl group, a cyclohexanecarbonyl group, an oleoyl group, a benzoyl group, a naphthylcarbonyl group, a cinnamoyl group, etc. Of those, preferred are a propionyl group, a butanoyl group, a dodecanoyl group, an octadecanoyl group, a tert-butanoyl group, an oleoyl group, a benzoyl group, a naphthylcarbonyl group, a cinnamoyl group, etc.; more preferred are a propionyl group and a butanoyl group.

In case where an acid anhydride or an acid chloride is used as the acylating agent for acylation of cellulose, an organic acid such as acetic acid, or methylene chloride or the like may be used as the organic solvent to be the reaction solvent.

In case where the acylating agent is an acid anhydride, the catalyst is preferably a protic catalyst such as sulfuric acid; and in case where the acylating agent is an acid chloride (e.g., CH₃CH₂COCl), a basic compound may be used as the catalyst.

A most popular industrial-scale production method for a mixed fatty acid ester of cellulose comprises acylating cellulose with a mixed organic acid component that contains a fatty acid (e.g., acetic acid, propionic acid, valeric acid) corresponding to an acetyl group or other acyl group, or its acid anhydride.

The cellulose acylate for use in the invention can be produced, for example, according to the method described in JP-A 10-45804.

<Regions Differing from Each Other in Birefringence>

### (Angle to Slow Axis)

The film of the invention has a first region and a second region that differ from each other in the birefringence, wherein the angle between the slow axis of the first region and the slow axis of the second region is at least 45 degrees.

In this, the two regions that differ from each other in the birefringence mean include a case of two regions that differ from each other in point of the direction in which each region expresses the birefringence thereof and a case of two regions that are the same in point of the absolute value of the birefringence thereof but differ from each other in the sign of the birefringence.

In the film of the invention, the angle between the slow axis of the first region and the slow axis of the second region is at least 45 degrees, and the film can fully change the polarization state of the light having passed through the first region and the second region thereof.

The direction of the slow axis can be determined by KOBRA 21ADH or WR. In the invention, the direction of the slow axis is determined by the use of KOBRA 21ADH (by Oji Scientific Instruments).

In the film of the invention, preferably, the slow axis of the first region and the slow axis of the second ration are nearly perpendicular to each other from the viewpoint that the polarization state of the light having passed through the first region and the second region can be converted from linear polarization to circular polarization or from circular polarization to linear polarization in 3D image display.

In the film of the invention, more preferably, the slow axis of the first region and the slow axis of the second ration are perpendicular to each other from the viewpoint that the polarization state of the light having passed through the first region and the second region can be converted from linear polarization to circular polarization or from circular polarization to linear polarization, but not to elliptic polarization in any case, in 3D image display.

### (Polymer Alignment Direction)

In the film of the invention, preferably, the alignment direction of the polymer constituting the first region and the alignment direction of the polymer constituting the second region are substantially the same direction from the viewpoint of improving the film surface condition.

The polymer as referred to herein includes, in addition to the above-mentioned cellulose, any other alignable polymer, if any, in the film.

As compared with the patterned retardation film produced according to a conventional production method, the film of the invention tends to have a bettered surface condition. Concretely the film of the invention is compared with the film produced according to a conventional production method. For example, the patterned retardation film produced according to a conventional method of erasing the alignment direction of the polymer in the film or changing the alignment direction thereof may be roughened on the surface thereof with the change in the alignment condition thereof. Not adhering to any theory, it is considered that the surface condition of the patterned retardation film produced according to a conventional production method would be worsened since the molecules themselves constituting the film would be rotated or overlapped during the film production. Also in a conventional production method where two materials originally differing from each other in the birefringence are arranged so that their slow axes differ from each other and the unnecessary part is etched away or physically cut off after patterning, it is considered that the surface condition of the patterned retardation film produced therein would be worsened during etching or cutting.

As opposed to this, the film of the invention is stretched as a whole, and therefore even when the part to form the first region is heated so that the direction of the slow axis in the first region is thereby changed, it may be anticipated that the alignment direction of the polymer in the first region would not still change. Consequently, in the film of the invention, it is desirable that the alignment direction of the polymer constituting the first region and the alignment direction of the polymer constituting the second region are substantially the same direction from the viewpoint of improving the surface condition of the film.

### (Retardation)

Preferably, the optical film of the invention is such that the Re value of all the first region contained in the optical film and the Re value of all the second region contained in the optical film are from 30 to 250 nm, more preferably from 50 to 230 nm, even more preferably from 100 to 200 nm, still more preferably from 105 to 180 nm, furthermore preferably from 115 to 160 nm, and especially preferably from 130 to 150 nm.

In this description, Re(λ) and Rth(λ) mean the in-plane retardation and the thickness-direction retardation, respectively, at a wavelength of λ. Re(λ) may be measured by applying a light having a wavelength of λ nm in the normal direction of the film being analyzed, using KOBRA 21ADH or WR (by Oji Scientific Instruments).

In case where the film to be analyzed is expressed as a monoaxial or biaxial index ellipsoid, Rth(λ) thereof may be computed as follows:

With the in-plane slow axis (determined by KOBRA 21ADH or WR) taken as the tilt axis (rotation axis) of the film (in case where the film has no slow axis, the rotation axis of the film may be in any in-plane direction of the film), Re(λ) of the film is measured at 6 points in all thereof, from the normal direction of the film up to 50 degrees on one side relative to the normal direction thereof at intervals of 10 degrees, by applying a light having a wavelength of λ nm from the tilted direction of the film. Based on the thus-determined retardation data, the assumptive mean refractive index and the inputted film thickness, Rth (λ) of the film is computed with KOBRA 21ADH or WR.

In the above, when the film has a direction in which the retardation thereof is zero at a certain tilt angle relative to the in-plane slow axis thereof in the normal direction taken as a rotation axis, the sign of the retardation value of the film at the tilt angle larger than that tilt angle is changed to negative prior to computation with KOBRA 21ADH or WR.

With the slow axis taken as the tilt axis (rotation axis) of the film (in case where the film has no slow axis, the rotation axis of the film may be in any in-plane direction of the film), the retardation is measured in any desired tilted two directions, and based on the thus-determined retardation data, the assumptive mean refractive index and the inputted film thickness, Rth is computed according to the following formulae (A) and (B).

$$\begin{matrix} [ Numerical Formula 1 ] & \\ Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} & Formula ( A )\end{matrix}$$

### Notes:

The above Re (θ) means the retardation of the film in the direction tilted by an angle θ from the normal direction to the film.

In the formula (A), nx means the in-plane refractive index of the film in the slow axis direction; ny means the in-plane refractive index of the film in the direction perpendicular to nx; nz means the refractive index in the direction perpendicular to nx and ny.

Rth=((nx+ny)/2−nz)×d Formula (B)

In case where the film to be analyzed is not expressed as a monoaxial or biaxial index ellipsoid, or that is, when the film does not have an optical axis, Rth(λ) thereof may be computed as follows:

With the in-plane slow axis (determined by KOBRA 21ADH or WR) taken as the tilt axis (rotation axis) of the film, Re (λ) of the film is measured at 11 points in all thereof, in a range of from −50 degrees to +50 degrees relative to the film normal direction thereof at intervals of 10 degrees, by applying a light having a wavelength of λ nm from the tilted direction of the film. Based on the thus-determined retardation data, the assumptive mean refractive index and the inputted film thickness, Rth(λ) of the film is computed with KOBRA 21ADH or WR.

In the above measurement, for the assumptive mean refractive index, referred to are the data in Polymer Handbook (John Wiley & Sons, Inc.) or the data in the catalogues of various optical films. Films of which the mean refractive index is unknown may be analyzed with an Abbe's refractiometer to measure the mean refractive index thereof. Data of the mean refractive index of some typical optical films are mentioned below.

Cellulose acylate (1.48), cycloolefin polymer (1.52), polycarbonate (1.59), polymethyl methacrylate (1.49), polystyrene (1.59).

With the assumptive mean refractive index and the film thickness inputted thereinto, KOBRA 21ADH or WR can compute nx, ny and nz.

In this description, unless otherwise specifically indicated, the wavelength for measurement is 590 nm.

### (Profile of First Region and Second Region)

In the optical film of the invention, preferably, the first region and the second region are stripe ones of which the length of the short side is nearly equal to each other, and are patterned alternately repeatedly from the viewpoint of using the film for 3D stereoscopic image display systems.

In the optical film of the invention, preferably, the boundary between the first region and the second region does not contain an adhesive or a bond from the viewpoint of reducing the production cost. This is also desirable from the viewpoint of bettering the film surface condition.

In the film of the invention, the first region and the second region can be formed of one film according to the production method to be mentioned below, never physically separated from each other. Therefore, the first region and the second region can be fully adhered to each other even though an adhesive or a bond is not used in the boundary between the first region and the second region.

In the optical film of the invention, preferably, the first region and the second region are stripe ones, and the angle between the long-side direction of the stripe regions and the alignment directions that are substantially the same directions of the polymers constituting the first region and the second region is around 45 degrees.

Having the embodiment, when the film is used directly in place of the patterned retardation film used in ordinary polarized-glasses-system 3D stereoscopic image display devices, the film realizes observation of good 3D stereoscopic images without requiring any additional processing or any additional optical member.

Concretely, in case where the first region and the second region of the optical film of the invention are stripe ones, preferably, the width of each region is so determined as to correspond to the line width of a 3D stereoscopic image display panel, and is, for example, preferably 200 μm or so.

### <Layer Configuration of Film>

The film of the invention may be a single-layered film or may comprise 2 or more layers, but is preferably a single-layered film from the viewpoint of reducing the production cost.

According to the film production method of the invention, a so-called patterned retardation film as in the invention can be produced as a single-layered film.

### <Film Thickness>

The thickness of the film of the invention is preferably from 10 to 1000 μm from the viewpoint of reducing the production cost, more preferably from 40 to 500 μm, even more preferably from 40 to 200 μm.

### <Film Composition>

In the optical film of the invention, preferably the composition of the first region and the composition of the second region are the same from the viewpoint of reducing the production cost.

The embodiment where the compositions of the two regions are the same means that the type of the cellulose acylate in each region is the same and the types of the other additives therein are also the same, and their proportions in each region are also the same, in which, however, the alignment condition and of the compound contained in each region as well as the slow axis of each region may differ.

In the invention, the angle between the slow axis of the first region and the slow axis of the second region can be at least 45 degrees even though different polymers are not used in the first region and the second region, or different additives are not added thereto; and accordingly, the production cost of the film to be obtained in the invention can be favorably reduced.

### <Additive>

Various additives may be added to the film of the invention, for example, a compound having a positive intrinsic birefringence (including compounds known as a plasticizer or UV absorbent), a compound having an IR absorption capability, inorganic fine particles (mat agent), a citrate, etc.

### (Compound Having Positive Intrinsic Birefringence)

Preferably, the optical film of the invention contains a compound having a positive intrinsic birefringence.

The compound having a positive intrinsic birefringence includes compounds known as a plasticizer, a UV absorbent, etc.

The film containing a compound having a positive intrinsic birefringence is preferred, since the Re expression in the stretching direction of the film is bettered. The content of the compound having a positive intrinsic birefringence is preferably from 1 to 35% by mass of the cellulose acylate in the film, more preferably from 4 to 30% by mass, even more preferably from 10 to 25% by mass.

### (1) Plasticizer Having Positive Intrinsic Birefringence

In the invention, as a compound having a positive intrinsic birefringence and serving as a plasticizer, high-molecular-weight additives mentioned below can be widely employed.

The high-molecular-weight additive is a compound having a recurring unit therein and preferably has a number-average molecular weight of from 700 to 10000. The high-molecular-weight additive functions to promote the evaporation speed of solvent or functions to reduce the residual solvent amount in the film in a solution casting method. Further the additive has other useful effects for film property improvement, for example, for improving the mechanical properties of the film, imparting softness to the film, imparting water absorption resistance thereto and reducing the moisture permeability of the film.

The number-average molecular weight of the high-molecular-weight additive, plasticizer having a positive intrinsic birefringence for use in the invention is more preferably from 200 to 10000, even more preferably from 200 to 5000, still more preferably from 200 to 2000.

The high-molecular-weight additive usable in the invention is described in detail hereinunder with reference to specific examples thereof. Needless-to-say, however, the high-molecular-weight additive, plasticizer having a positive intrinsic birefringence usable in the invention is not limited to those mentioned below.

The high-molecular-weight additive is selected from polyester polymers, polyether polymers, polyurethane polymers and their copolymers; and above all, preferred are aliphatic polyesters, aromatic polyesters, and copolymers containing an aliphatic residue and an aromatic residue.

### Polyester Polymer:

The polyester polymer for use in the invention is produced through reaction of a dicarboxylic acid component and a diol component. Preferably, the polymer is produced through reaction of a mixture of an aliphatic dicarboxylic acid having from 2 to 20 carbon atoms and an aromatic dicarboxylic acid having from 8 to 20 carbon atoms, and at least one diol selected from an aliphatic diol having from 2 to 12 carbon atoms, an alkyl ether diol having from 4 to 20 carbon atoms and an aromatic diol having from 6 to 20 carbon atoms. Both ends of the reaction product may be as such after the reaction, or may be processed for so-called end capping through reaction with a monocarboxylic acid, a monoalcohol or a phenol. The end capping is attained especially in order that the polymer could not contain any free carboxylic acid, and is effective from the viewpoint of storability of the polymer. The dicarboxylic acid for use for the polyester polymer in the invention is preferably for an aliphatic dicarboxylic acid residue having from 4 to 20 carbon atoms or an aromatic dicarboxylic acid residue having from 8 to 20 carbon atoms.

The aliphatic dicarboxylic acid having from 2 to 20 carbon atoms, as preferred for use in the invention, includes, for example, oxalic acid, malonic acid, succinic acid, maleic acid, fumaric acid, glutaric acid, adipic acid, pimelic acid, suberic acid, azelaic acid, sebacic acid, dodecanedicarboxylic acid, and 1,4-cyclohexanedicarboxylic acid.

The aromatic dicarboxylic acid having from 8 to 20 carbon atoms includes phthalic acid, terephthalic acid, isophthalic acid, 1,5-naphthalenedicarboxylic acid, 1,4-naphthalenedicarboxylic acid, 1,8-naphthalenedicarboxylic acid, 2,8-naphthalenedicarboxylic acid, and 2,6-naphthalenedicarboxylic acid.

Of those, preferred aliphatic dicarboxylic acids are malonic acid, succinic acid, maleic acid, fumaric acid, glutaric acid, adipic acid, azelaic acid, 1,4-cyclohexanedicarboxylic acid; and preferred aromatic dicarboxylic acids are phthalic acid, terephthalic acid, isophthalic acid, 1,5-naphthalenedicarboxylic acid, 1,4-naphthalenedicarboxylic acid. More preferred aliphatic dicarboxylic acid components are succinic acid, glutaric acid, adipic acid; and more preferred aromatic dicarboxylic acids are phthalic acid, terephthalic acid, isophthalic acid.

In the invention, a more preferred embodiment is using terephthalic acid or naphthalenedicarboxylic acid as the dicarboxylic acid component for the polyester polymer, and even more preferred is use of terephthalic acid.

The diol to be used for the polyester polymer as the high-molecular-weight additive is, for example, selected from an aliphatic diol having from 2 to 20 carbon atoms, an alkyl ether diol having from 4 to 20 carbon atoms, and an aromatic ring-containing diol having from 6 to 20 carbon atoms.

The aliphatic diol having from 2 to 20 carbon atoms includes alkyldiols and alicyclic diols, for example, ethanediol, 1,2-propanediol, 1,3-propanediol, 1,2-butanediol, 1,3-butanediol, 2-methyl-1,3-propanediol, 1,4-butanediol, 1,5-pentanediol, 2,2-dimethyl-1,3-propanediol (neopentyl glycol), 2,2-diethyl-1,3-propanediol (3,3-dimethylolpentane), 2-n-butyl-2-ethyl-1,3-propanediol (3,3-dimethylolheptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol, 1,12-octadecanediol, etc. One or more these aliphatic diols may be used here either singly or as a mixture thereof.

Preferred aliphatic diols are ethanediol, 1,2-propanediol, 1,3-propanediol, 1,2-butanediol, 1,3-butanediol, 2-methyl-1,3-propanediol, 1,4-butanediol, 1,5-pentanediol, 3-methyl-1,5-pentanediol, 1,6-hexanediol, 1,4-cyclohexanediol, 1,4-cyclohexanedimethanol; and more preferred are ethanediol, 1,2-propanediol, 1,3-propanediol, 1,2-butanediol, 1,3-butanediol, 1,4-butanediol, 1,5-pentanediol, 1,6-hexanediol, 1,4-cyclohexanediol, 1,4-cyclohexanedimethanol.

In the invention, more preferably, ethanediol or propanediol is used as the diol component for the polyester polymer; and even more preferred is use of ethanediol.

Preferred examples of the alkyl ether diol having from 4 to 20 carbon atoms include polytetramethylene ether glycol, polyethylene ether glycol, polypropylene ether glycol and their mixtures. Not specifically defined, the mean degree of polymerization of the compound is from 2 to 20, more preferably from 2 to 10, even more preferably from 2 to 5, still more preferably from 2 to 4. Typically useful commercially-available polyether glycols as their examples include Carbowax Resin Pluronics Resin and Niax Resin.

Not specifically defined, the aromatic diol having from 6 to 20 carbon atoms includes bisphenol A, 1,2-hydroxybenzene, 1,3-hydroxybenzene, 1,4-hydroxybenzene, 1,4-benzenedimethanol; and preferred are bisphenol A, 1,4-hydroxybenzene, 1,4-benzenedimethanol.

In the invention, the high-molecular-weight additive is end-capped with an alkyl group or an aromatic group. This is because protecting the compound at the end thereof with a hydrophobic functional group is effective against aging deterioration at high temperature and high humidity, and the end-capping plays the role of retarding the hydrolysis of the ester group.

Preferably, both ends of the polyester polymer are protected with a monoalcohol residue or a monocarboxylic acid residue in order that the ends are not a carboxylic acid or OH group.

In this case, the monoalcohol is preferably a substituted or unsubstituted monoalcohol having from 1 to 30 carbon atoms, including aliphatic alcohols such as methanol, ethanol, propanol, isopropanol, butanol, isobutanol, pentanol, isopentanol, hexanol, isohexanol, cyclohexyl alcohol, octanol, isooctanol, 2-ethylhexyl alcohol, nonyl alcohol, isononyl alcohol, tert-nonyl alcohol, decanol, dodecanol, dodecahexanol, dodecaoctanol, allyl alcohol, oleyl alcohol, etc.; and substituted alcohols such as benzyl alcohol, 3-phenylpropanol, etc.

Preferred end-capping alcohols for use herein are methanol, ethanol, propanol, isopropanol, butanol, isobutanol, isopentanol, hexanol, isohexanol, cyclohexyl alcohol, isooctanol, 2-ethylhexyl alcohol, isononyl alcohol, oleyl alcohol, benzyl alcohol; and more preferred are methanol, ethanol, propanol, isobutanol, cyclohexyl alcohol, 2-ethylhexyl alcohol, isononyl alcohol, benzyl alcohol.

In case where the ends are capped with a monocarboxylic acid residue, the monocarboxylic acid for the monocarboxylic acid residue is preferably a substituted or unsubstituted monocarboxylic acid having from 1 to 30 carbon atoms. The acid may be an aliphatic monocarboxylic acid or an aromatic ring-containing carboxylic acid. Preferred aliphatic monocarboxylic acids are described. There are mentioned acetic acid, propionic acid, butanoic acid, caprylic acid, caproic acid, decanoic acid, dodecanoic acid, stearic acid, oleic acid. As aromatic ring-containing monocarboxylic acids, for example, there are mentioned benzoic acid, p-tert-butylbenzoic acid, p-tert-amylbenzoic acid, orthotoluic acid, metatoluic acid, paratoluic acid, dimethylbenzoic acid, ethylbenzoic acid, normal-propylbenzoic acid, aminobenzoic acid, acetoxybenzoic acid, etc. One or more of these may be used here.

In the invention, more preferably, both ends of the polyester polymer are capped with acetic acid or propionic acid, even more preferably with acetic acid.

The high-molecular-weight additive for use in the invention can be easily produced according to any of a method of thermal melt condensation through polyesterification or interesterification of the above-mentioned dicarboxylic acid and diol and/or with the end-capping monocarboxylic acid or monoalcohol in an ordinary manner, or a method of interfacial condensation of an acid chloride of the acid and a glycol. The polyester additives are described in detail in Koichi Murai, “Plasticizers, Theory and Application Thereof” (by Miyuki Shobo Publishing, First Edition, No. 1, published on Mar. 1, 1973). Materials described in JP-A 05-155809, JP-A 05-155810, JP-A 5-197073, JP-A 2006-259494, JP-A 07-330670, JP-A 2006-342227, JP-A 2007-003679 are also usable here.

As commercial products also usable here are, there are mentioned Adekasizers (various commercial products of Adekasizer P Series, Adekasizer PN Series) shown in Adeka's DIARY 2007, pp. 55-27 as polyester plasticizers; various commercial products of Polylite shown in DIC's “List of Polymer-Related Products 2007”, p. 25; various polysizers shown in DIC's “DIC Polymer Modifiers” (000VIII, published Apr. 1, 2004), pp. 2-5. Further, commercial products of Plasthall P Series are available from US CP HALL. Benzoyl-functionalized polyethers are commercially sold as a trade name of BENZOFLEX from Velsicol Chemicals of Rosemont, Ill. (for example, BENZOFLEX 400, polypropylene glycol dibenzoate).

Specific examples of the polyester polymer usable in the invention are shown below; however, the polyester polymer for use in the invention is not limited to these.

Compound AA: ethanediol/terephthalic acid (1/1 by mol) condensate with both ends capped with acetate (number-average molecular weight 1000).
PP-1: ethanediol/succinic acid (1/1 by mol) condensate (number-average molecular weight 2500).
PP-2: 1,3-propanediol/glutaric acid (1/1 by mol) condensate (number-average molecular weight 1500).
PP-3: 1,3-propanediol/adipic acid (1/1 by mol) condensate (number-average molecular weight 1300).
PP-4: 1,3-propanediol/ethylene glycol/adipic acid (1/1/2 by mol) condensate (number-average molecular weight 1500).
PP-5: 2-methyl-1,3-propanediol/adipic acid (1/1 by mol) condensate (number-average molecular weight 1200).
PP-6: 1,4-butanediol/adipic acid (1/1 by mol) condensate (number-average molecular weight 1500).
PP-7: 1,4-cyclohexanediol/succinic acid (1/1 by mol) condensate (number-average molecular weight 800).
PP-8: 1,3-propanediol/succinic acid (1/1 by mol) condensate with both ends capped with butyl ester (number-average molecular weight 1300).
PP-9: 1,3-propanediol/glutaric acid (1/1 by mol) condensate with both ends capped with cyclohexyl ester (number-average molecular weight 1500).
PP-10: ethanediol/succinic acid (1/1 by mol) condensate with both ends capped with 2-ethylhexyl ester (number-average molecular weight 3000).
PP-11: 1,3-propanediol/ethylene glycol/adipic acid (1/1/2 by mol) condensate with both ends capped with isononyl ester (number-average molecular weight 1500).
PP-12: 2-methyl-1,3-propanediol/adipic acid (1/1 by mol) condensate with both ends capped with propyl ester (number-average molecular weight 1300).
PP-13: 2-methyl-1,3-propanediol/adipic acid (1/1 by mol) condensate with both ends capped with 2-ethylhexyl ester (number-average molecular weight 1300).
PP-14: 2-methyl-1,3-propanediol/adipic acid (1/1 by mol) condensate with both ends capped with isononyl ester (number-average molecular weight 1300).
PP-15: 1,4-butanediol/adipic acid (1/1 by mol) condensate with both ends capped with butyl ester (number-average molecular weight 1800).
PP-16: ethanediol/terephthalic acid (1/1 by mol) condensate (number-average molecular weight 2000).
PP-17: 1,3-propanediol/1,5-naphthalenedicarboxylic acid (1/1 by mol) condensate (number-average molecular weight 1500).
PP-18: 2-methyl-1,3-propanediolasophthalic acid (1/1 by mol) condensate (number-average molecular weight 1200).
PP-19: 1,3-propanediol/terephthalic acid (1/1 by mol) condensate with both ends capped with benzyl ester (number-average molecular weight 1500).
PP-20:1,3-propanediol/1,5-naphthalenedicarboxylic acid (1/1 by mol) condensate with both ends capped with propyl ester (number-average molecular weight 1500).
PP-21: 2-methyl-1,3-propanediol/isophthalic acid (1/1 by mol) condensate with both ends capped with butyl ester (number-average molecular weight 1200).
PP-22: poly(mean degree of polymerization 5)propylene ether glycol/succinic acid (1/1 by mol) condensate (number-average molecular weight 1800).
PP-23: poly(mean degree of polymerization 3)ethylene ether glycol/glutaric acid (1/1 by mol) condensate (number-average molecular weight 1600).
PP-24: poly(mean degree of polymerization 4)propylene ether glycol/adipic acid (1/1 by mol) condensate (number-average molecular weight 2200).
PP-25: poly(mean degree of polymerization 4)propylene ether glycol/phthalic acid (1/1 by mol) condensate (number-average molecular weight 1500).
PP-26: poly(mean degree of polymerization 5)propylene ether glycol/succinic acid (1/1 by mol) condensate with both ends capped with butyl ester (number-average molecular weight 1900).
PP-27: poly(mean degree of polymerization 3)ethylene ether glycol/glutaric acid (1/1 by mol) condensate with both ends capped with 2-ethylhexyl ester (number-average molecular weight 1700).
PP-28: poly(mean degree of polymerization 4)propylene ether glycol/adipic acid (1/1 by mol) condensate with both ends capped with tert-nonyl ester (number-average molecular weight 1300).
PP-29: poly(mean degree of polymerization 4)propylene ether glycol/phthalic acid (1/1 by mol) condensate with both ends capped with propyl ester (number-average molecular weight 1600).
PP-30: polyester urethane compound prepared through condensation of 1,3-propanediol/succinic acid (1/1 by mol) condensate (number-average molecular weight 1500) with trimethylene diisocyanate (1 mol).
PP-31: polyester-urethane compound prepared through condensation of 1,3-propanediol/glutaric acid (1/1 by mol) condensate (number-average molecular weight 1200) with tetramethylene diisocyanate (1 mol).
PP-32: polyester-urethane compound prepared through condensation of 1,3-propanediol/adipic acid (1/1 by mol) condensate (number-average molecular weight 1000) with p-phenylene diisocyanate (1 mol).
PP-33: polyester-urethane compound prepared through condensation of 1,3-propanediol/ethylene glycol/adipic acid (1/1/2 by mol) condensate (number-average molecular weight 1500) with tolylene diisocyanate (1 mol).
PP-34: polyester-urethane compound prepared through condensation of 2-methyl-1,3-propanediol/adipic acid (1/1 by mol) condensate (number-average molecular weight 1200) with m-xylylene diisocyanate (1 mol).
PP-35: polyester-urethane compound prepared through condensation of 1,4-butanediol/adipic acid (1/1 by mol) condensate (number-average molecular weight 1500) with tetramethylene diisocyanate (1 mol).
PP-36: polyisopropyl acrylate (number-average molecular weight 1300).
PP-37: polybutyl acrylate (number-average molecular weight 1300).
PP-38: polyisopropyl methacrylate (number-average molecular weight 1200).
PP-39: poly(methyl methacrylate/butyl methacrylate) (8/2 by mol) (number-average molecular weight 1600).
PP-40: poly(methyl methacrylate/2-ethylhexyl methacrylate) (9/1 by mol) (number-average molecular weight 1600).
PP-41: poly(vinyl acetate) (number-average molecular weight 2400).

Of the above-mentioned polymer compounds, the compounds known as an optical anisotropy controlling agent are preferably used in the invention. The optical anisotropy controlling agent is described in JP-A 2005-104148.

The high-molecular-weight additive is preferably combined with a cellulose acylate having a high total degree of acylation from the viewpoint of axis inversion.

In the invention, the above-mentioned Compound AA which is an optical anisotropy controlling agent is especially preferably used as the plasticizer having a positive intrinsic birefringence. The Compound AA is preferred from the viewpoint of combining it with a cellulose acylate having a high total degree of acylation.

### (2) UV Absorbent Having Positive Intrinsic Birefringence

Preferably, the film of the invention contains the above-mentioned UV absorbent having a positive intrinsic birefringence from the viewpoint of axis inversion.

As the UV absorbent having a positive intrinsic birefringence, there are mentioned the UV absorbents described in JP-A 2009-262551.

Specific examples of the UV absorbent having a positive intrinsic birefringence are shown below; however, the invention is not limited to these compounds.

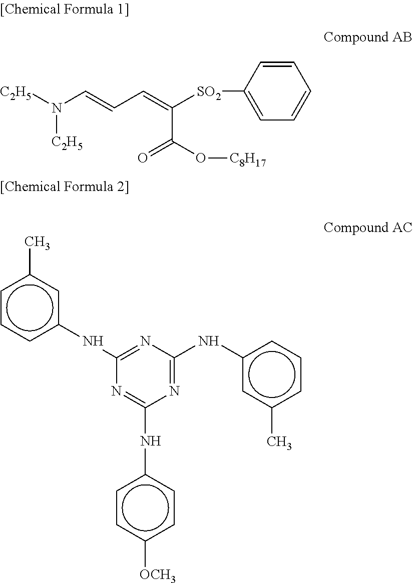

### (Compound Having IR Absorption Capability)

Preferably, the optical film of the invention contains a compound having an IR absorption capability from the viewpoint that, in the step of heating a partial region in the production method for an optical film of the invention to be mentioned below, the efficiency in thermal irradiation with an IR laser can be increased.

As the compound having an IR absorption capability, widely usable here are compounds known as an additive to cellulose acylate films, for example, as described in JP-A 2001-194522. Other preferred examples of the compound are diimmonium salts.

Above all, preferred are diimmonium salts (for example, KAYASORB IRG-022 (by Nippon Kayaku, λmax=1100 nm), and aminium salts; and more preferred are diimmonium salts.

### (Inorganic Fine Particles)

Preferably, inorganic fine particles (mat agent) are added to the film of the invention. As the inorganic fine particles for use in the invention, there are mentioned silicon dioxide, titanium dioxide, aluminium oxide, zirconium oxide, calcium carbonate, calcium carbonate, talc, clay, fired kaolin, fired calcium silicate, calcium silicate hydrate, aluminium silicate, magnesium silicate and calcium phosphate. Preferably, the inorganic fine particles are those containing silicon from the viewpoint of reducing the turbidity of the film, and more preferred is silicon dioxide. The fine particles of silicon dioxide are preferably those having a primary mean particle size of at most 20 nm and an apparent specific gravity of at least 70 g/liter. More preferred are those of which the primary particles have a mean particle size of from 5 to 30 nm from the viewpoint that the total haze of the film can be controlled to fall within the scope of the invention. The apparent specific gravity of the particles is more preferably from 10 to 100 g/liter or more, even more preferably from 30 to 80 g/liter or more.

In case where the film of the invention has a two-layered laminate structure, the inorganic fine particles are contained in at least one outermost layer of the film. In case where the film of the invention has a three-layered or more multi-layered laminate structure, preferably, the inorganic fine particles are contained in both the outer layers of the film.

The fine particles form secondary particles generally having a mean particle size of from 0.1 to 3.0 μm, and these fine particles exist as aggregates of primary particles thereof in the film, therefore forming irregularities of from 0.1 to 3.0 μm on the film surface. Preferably, the secondary mean particle size is from 0.2 μm to 1.5 μm, more preferably from 0.4 μm to 1.2 μm, most preferably from 0.6 μm to 1.1 μm. For the primary or secondary particle size, the particles in the film are observed with a scanning electronic microscope, and the diameter of the circumscribed circle around the particle is measured to be the particle size. 200 particles are observed at different sites, and the data are averaged to give the mean particle size.

As the fine particles of silicon dioxide, for example, herein usable are commercial products of Aerosil R972, R972V, R974, R812, 200, 200V, 300, R202, OX50, TT600 (all by Nippon Aerosil), etc. Fine particles of zirconium oxide are commercially sold as a trade name of Aerosil R976 and R811 (both by Nippon Aerosil), and are usable here.

Of those, especially preferred is Aerosil R972 from the viewpoint of the aggregability thereof in preparing a dispersion of the inorganic fine particles.

In the invention, for obtaining a film that contains particles having a small secondary mean particle size, some methods may be taken into consideration for preparing the dispersion of the fine particles. For example, there is a method of previously preparing a fine particles dispersion by stirring and mixing fine particles in a solvent, adding the fine particles dispersion to a small amount of a cellulose acylate solution separately prepared and dissolving it therein, and further mixing the resulting liquid with a main liquid of cellulose acylate dope. This preparation method is preferred in that the silicon dioxide fine particles well disperse and the silicon dioxide fine particles hardly reaggregate. Apart from it, there is also mentioned a method of adding a small amount of a cellulose ester to a solvent, then stirring and dissolving it, adding fine particles thereto and dispersing them with a disperser to give a fine particles additive solution, and fully mixing the fine particles additive liquid with a dope liquid in an in-line mixer. The invention is not limited to these methods. When silicon dioxide fine particles are dispersed in a solvent by mixing them therein, the concentration of silicon dioxide is preferably from 5 to 30% by mass, more preferably from 10 to 25% by mass, most preferably from 15 to 20% by mass. The dispersion concentration is preferably higher since the liquid turbidity relative to the added amount could be lower, the haze of the film could be lower and the formation of aggregates could be prevented more. The amount of the mat agent to be added in the final cellulose acylate dope liquid is preferably from 0.01 to 1.0 g/m², more preferably from 0.03 to 0.3 g/m², most preferably from 0.08 to 0.16 g/m².

Lower alcohols are usable here as the solvent, and preferred are methyl alcohol, ethyl alcohol, propyl alcohol, isopropyl alcohol, butyl alcohol, etc. Other solvents than lower alcohols usable here are not specifically defined. Preferably, the solvent to be used in formation of cellulose ester films is used here.

### (Citrate Ester)

Preferably, the optical film of the invention contain a citrate ester.

Containing a citrate ester, the film can be readily peeled off from a metal support in casting film formation, and the embodiment is preferred here.

### [Production Method for Optical Film]

The production method for an optical film of the invention comprises a step of stretching the entire film containing a cellulose acylate in a specific direction and a step of heating a partial region of the stretched film in such a manner that the slow axis formed by the stretching in the partial region could rotate by at least 45 degrees.

In the production method for an optical film of the invention, the above-mentioned cellulose acylate-containing film can be produced according to a solution casting film formation method or a melt casting film formation method.

### (Polymer Solution)

In the solution casting film formation method, a polymer solution containing the above-mentioned cellulose acylate and optionally various additives (cellulose acylate solution) is used to form a web. The polymer solution for use in the solution casting film formation method in the invention (hereinafter this may be referred to as a cellulose acylate solution) is described below.

The main solvent of the polymer solution in the invention is preferably an organic solvent that is a good solvent for cellulose acylate. The organic solvent of the type is preferably an organic solvent having a boiling point of not higher than 80° C. from the viewpoint of reducing the drying load. More preferably, the boiling point of the organic solvent is from 10 to 80° C., even more preferably from 20 to 60° C. As the case may be, an organic solvent having a boiling point of from 30 to 45° C. is also preferably used as the main solvent. In the invention, of the solvent group to be mentioned below, halogenohydrocarbons are especially preferably used as the main solvent. Of halogenohydrocarbons, more preferred are chlorohydrocarbons, even more preferred are dichloromethane and chloroform, and most preferred is dichloromethane. A solvent having a boiling point of not lower than 95° C., which is poorly volatile along with halogenohydrocarbons in the initial stage of the drying step and which is therefore gradually concentrated in the system can be used in an amount of from 1 to 15% by mass of all the solvents, and preferably, the proportion of the solvent of the type is from 1 to 10% by mass, more preferably from 1.5 to 8% by mass. The solvent having a boiling point of not lower than 95° C. is preferably a poor solvent for cellulose acylate. As specific examples of the solvent having a boiling point of not lower than 95° C., there are mentioned the solvents having a boiling point of not lower than 95° C. of specific examples of “organic solvent to be used along with main solvent” to be mentioned below. Above all, preferred are butanol, pentanol and 1,4-dioxane. Further, the solvent for the polymer solution for use in the invention preferably contains an alcohol in an amount of from 5 to 40% by mass, preferably from 10 to 30% by mass, more preferably from 12 to 25% by mass, even more preferably from 15 to 25% by mass. As specific examples of the usable alcohol, there are mentioned the solvents exemplified as alcohols of “organic solvent to be used along with main solvent” to be mentioned below. Above all, preferred are methanol, ethanol, propanol and butanol. Incase where the “solvent having a boiling point of not lower than 95° C.” is an alcohol such as butanol or the like, the content thereof shall be counted as the alcohol content referred to herein. Using the solvent of the type enhances the mechanical strength of the formed cellulose acylate film at the heat treatment temperature thereof, and therefore the film can be prevented from broken as a result of more excessive stretching in heat treatment than necessary.

As the main solvent, especially preferred are halogenohydrocarbons. As the case may be, esters, ketones, ethers, alcohols and hydrocarbons are also usable. These may have a branched structure or a cyclic structure. The main solvent may have any two or more functional groups of those esters, ketones, ethers and alcohols (that is, —O—, —CO—, —COO—, —OH). Further, the hydrogen atom in the hydrocarbon moiety of esters, ketones, ethers and alcohols may be substituted with a halogen atom (especially fluorine atom). In case where the solvent of the polymer solution to be used in producing the cellulose acylate film of the invention according to the production method of the invention is a single solvent, the main solvent means the solvent itself; but in case where the solvent is composed of different types of solvents, the main solvent means the solvent having a highest mass fraction of all the constituent solvents. The main solvent is preferably a halogenohydrocarbons.

The halogenohydrocarbons is preferably a chlorohydrocarbon, for example, including dichloromethane and chloroform. More preferred is dichloromethane.

The ester includes, for example, methyl formate, ethyl formate, methyl acetate, ethyl acetate, etc.

The ketone includes, for example, acetone, methyl ethyl ketone, etc.

The ether includes, for example, diethyl ether, methyl tert-butyl ether, diisopropyl ether, dimethoxymethane, 1,3-dioxolane, 4-methyldioxolane, tetrahydrofuran, methyltetrahydrofuran, 1,4-dioxane, etc.

The alcohol includes, for example, methanol, ethanol, 2-propanol, etc.

The hydrocarbon includes, for example, n-pentane, cyclohexane, n-hexane, benzene, toluene, etc.

The organic solvent that may be used along with the main solvent includes halogenohydrocarbons, esters, ketones, ethers, alcohols and hydrocarbons, and these may have a branched structure or a cyclic structure. The organic solvent may have any two or more functional groups of esters, ketones, ethers and alcohols (that is, —O—, —CO—, —COO—, —OH). Further, the hydrogen atom in the hydrocarbon moiety of those esters, ketones, ethers and alcohols may be substituted with a halogen atom (especially fluorine atom).

The halogenohydrocarbons is preferably a chlorohydrocarbon, including, for example, dichloromethane and chloroform. Dichloromethane is more preferred.

The ester includes, for example, methyl formate, ethyl formate, propyl formate, pentyl formate, methyl acetate, ethyl acetate, pentyl acetate, etc.

The ketone includes, for example, acetone, methyl ethyl ketone, diethyl ketone, diisobutyl ketone, cyclopentanone, cyclohexanone, methylcyclohexanone, etc.

The ether includes, for example, diethyl ether, methyl tert-butyl ether, diisopropyl ether, dimethoxymethane, 1,4-dioxane, 1,3-dioxolane, 4-methyldioxolane, tetrahydrofuran, methyltetrahydrofuran, anisole, phenetole, etc.

The alcohol includes, for example, methanol, ethanol, 1-propanol, 2-propanol, 1-butanol, 2-butanol, tert-butanol, 1-pentanol, 2-methyl-2-butanol, cyclohexanol, 2-fluoroethanol, 2,2,2-trifluoroethanol, 2,2,3,3-tetrafluoro-1-propanol, etc. Preferred are alcohols having from 1 to 4 carbon atoms; more preferred are methanol, ethanol and butanol; and most preferred are methanol and butanol. The hydrocarbon includes, for example, n-pentane, cyclohexane, n-hexane, benzene, toluene, xylene, etc. The organic solvent having two or more different types of functional groups includes, for example, 2-ethoxyethyl acetate, 2-methoxyethanol, 2-butoxyethanol, methyl acetacetate, etc.

In the invention, the polymer to constitute the cellulose acylate film contains a hydrogen-bonding functional group such as a hydroxyl group or a residue of an ester, a ketone or the like, and therefore the solvent preferably contains an alcohol in an amount of from 5 to 30% by mass of all the solvents, more preferably from 7 to 25% by mass, even more preferably from 10 to 20% by mass from the viewpoint of reducing the film peeling load from casting support.

Controlling the alcohol content facilitates control of Re and Rth expressibility in the cellulose acylate film produced according to the production method of the invention. Concretely, increasing the alcohol content may relatively lower the thermal treatment temperature for the film or may enlarge the ultimate range of Re and Rth of the film.

In addition, in the invention, it is effective to make the film contain a small amount of water for the purpose of increasing the filming dope viscosity or for increasing the wet film strength in drying the film or for increasing the dope strength in casting film formation on a drum. For example, the filming dope may contain water in an amount of from 0.1 to 5% by mass of the entire dope, more preferably from 0.1 to 3% by mass, even more preferably from 0.2 to 2% by mass.

Examples of preferred combinations of organic solvents for use for the polymer solution in the invention are described in JP-A 2009-262551.

If desired, a non-halogen organic solvent may be used as the main solvent, and its detailed description is in a Hatsumei Kyokai Disclosure Bulletin (No. 2001-1745, published on Mar. 15, 2001 by Hatsumei Kyokai).

The cellulose acylate concentration in the polymer solution in the invention is preferably from 5 to 40% by mass, more preferably from 10 to 30% by mass, even more preferably from 15 to 30% by mass.

The cellulose acylate concentration may be controlled by dissolving a cellulose acylate in a solvent to have a desired concentration therein. As the case may be, a solution having a low concentration (for example, from 4 to 14% by mass) may be previously prepared, and then the solvent may be evaporated away to concentrate the solution. Also, a high-concentration solution is previously prepared and may be diluted later. Additive addition may lower the cellulose acylate concentration.

The time when the additive is added may be suitably fixed depending on the type of the additive.

Preferably, the additive to be used in the cellulose acylate film of the invention is substantially nonvolatile in the drying step for film formation. The increase in the amount of the additive to be added may lower the glass transition temperature (Tg) of the polymer film or may cause the problem of additive evaporation during the film production process, and therefore, the amount of the additive having a molecular weight of not more than 3000 is preferably from 0.01 to 30% by mass of the polymer, more preferably from 2 to 30% by mass, even more preferably from 5 to 20% by mass.

### (Preparation of Polymer Solution)

In the invention, the polymer solution may be prepared, for example, according to the preparation method described in JP-A 58-127737, JP-A 61-106628, JP-A 2-276830, JP-A 4-259511, JP-A 5-163301, JP-A 9-95544, JP-A 10-45950, JP-A 10-95854, JP-A 11-71463, JP-A 11-302388, JP-A 11-322946, JP-A 11-322947, JP-A 11-323017, JP-A 2000-53784, JP-A2000-273184, JP-A2000-273239. Concretely, a polymer and a solvent are mixed, stirred and swollen, and if desired, cooled or heated, and the resulting solution is filtered to give the polymer solution for use in the invention.

In the invention, the process preferably includes a step of cooling and/or heating the mixture of the polymer and the solvent for the purpose of enhancing the dissolution of the polymer in the solvent.

In case where a halogen-containing organic solvent is used and the mixture of a cellulose acylate and the solvent is cooled, preferably, the process includes a step of cooling the mixture to −100 to 10° C. Also preferably, the process includes a step of swelling the system at −10 to 39° C. prior to the cooling step, and includes a step of heating the system at 0 to 39° C. after the cooling step.

In case where a halogen-containing organic solvent is used and the mixture of a cellulose acylate and the solvent is heated, the process preferably includes a step of dissolving the cellulose acylate in the solvent according to any one or more methods selected from the following (a) and (b).

(a) After swollen at −10 to 39° C., the resulting mixture is heated at 0 to 39° C.

(b) After swollen at −10 to 39° C., the resulting mixture is heated at 0.2 to 30 MPa and at 40 to 240° C. and the heated mixture is cooled to 0 to 39° C.

Further, in case where a non-halogen organic solvent is used and the mixture of a cellulose acylate and the solvent is cooled, the process preferably includes a step of cooling the mixture at −100 to −10° C. Also preferably, the process includes a step of swelling the mixture at −10 to 55° C. prior to the cooling step and heating the mixture at 0 to 57° C. after the cooling step.

In case where a halogen-containing organic solvent is used and the mixture of a cellulose acylate and the solvent is heated, the process preferably includes a step of dissolving the cellulose acylate in the solvent according to any one or more methods selected from the following (c) and (d).

(c) After swollen at −10 to 55° C., the resulting mixture is heated at 0 to 57° C.

(d) After swollen at −10 to 55° C., the resulting mixture is heated at 0.2 to 30 MPa and at 40 to 240° C. and the heated mixture is cooled to 0 to 57° C.

### (Web Formation)

In the invention, the web may be formed according to a solution casting method where the polymer solution for the invention is used. In carrying out the solution casting film formation method, any known apparatus may be used according to a conventional method. Concretely, the dope (polymer solution in the invention) prepared in a dissolver (tank) is filtered, then once stored in a reservoir and defoamed to remove the foams from the dope to prepare the final dope. The dope is kept at 30° C., and fed to a pressure die from a dope discharge mouth via a pressure metering gear pump capable of feeding the dope at a constant flow rate, then the dope is uniformly cast onto the metal support in the endlessly running casting unit (dope casting step). Next, at the peeling point at which the metal support has circled nearly around, the wet dope film (web) is peeled from the metal support, then conveyed into the drying zone in which the web is dried while conveyed with rolls therethrough. The details of the casting step and the drying step in the solution casting film formation method are described in JP-A 2005-104148, pp. 120-140, which may apply also to the invention.

In the invention, as the metal support for use in web formation, a metal band or a metal drum may be used.

### (Stretching Step)

The production method for an optical film of the invention includes a step of stretching the entire film containing a cellulose acylate in a specific direction. In the production method of the invention, the entire film is stretched in a specific direction whereby the alignment direction of the polymer constituting the first region of the film of the invention could be substantially the same as the alignment direction of the polymer constituting the second region thereof.

Preferably, in the production method for an optical film of the invention, the specific direction in the stretching step (stretching direction) is the film traveling direction or an oblique direction by about 45 degrees to the film traveling direction, and from the viewpoint of easily laminating the optical film on a polarizer in a mode of roll-to-roll lamination in the production method for a polarizer to be mentioned below, the stretching direction is more preferably an oblique direction by about 45 degrees to the film traveling direction. When the stretching direction is an oblique direction by about 45 degrees to the film traveling direction, it is unnecessary to blank the polarizer obtained as a roll, in an oblique direction so that the production cost in polarizer production can be thereby reduced.

In this, the residual solvent amount in the web at the start of stretching the web is preferably from 20 to 300% by mass.

### [Residual Solvent Amount]

The residual solvent amount in the cellulose acylate web at the start of stretching can be computed according to the following formula:

Residual Solvent Amount (% by mass)={(M−N)/N}×100

[In the formula, M is the mass of the cellulose acylate film just before inserted into the stretching zone, and N is the mass of the cellulose acylate film just before inserted into the stretching zone and dried at 110° C. for 3 hours.]

In the stretching step in the invention, the residual solvent amount at the start of stretching the web is preferably from 20 to 300% by mass, and in consideration of the balance between the peelability and the breaking resistance of the web, and the stretching temperature and the draw ratio in stretching, the residual solvent amount is more preferably from 150 to 250% by mass, even more preferably from 200 to 250% by mass. When the residual solvent amount is at least 20% by mass, then the web hardly breaks in stretching even though the stretching temperature is low. Accordingly, the stretching temperature may be set low and the energy efficiency can be thereby enhanced. Further, when the residual solvent amount is at least 20% by mass, then the heat treatment temperature in heat treatment after stretching for the purpose of enhancing Re of the cellulose acylate film can be lowered and the heat treatment time therefor can be shortened. As a result, the film discoloration can be prevented, and the film recoverability can be greatly improved. On the other hand, when the residual solvent amount is at most 300% by mass, then the peelability and the stretchability (wrinkling resistance, handleability) of web as well as the recoverability thereof can be greatly improved. In particular, when the residual solvent amount falls within a range of from 150 to 250% by mass, then the draw ratio in stretching can be readily increased and further the web can be more effectively prevented from breaking.

The residual solvent amount in the cellulose acylate web can be suitably controlled by changing the concentration of the polymer solution in the invention, the temperature and the speed of the metal support, the temperature and the amount of the dry air, the solvent gas concentration in the drying atmosphere, etc.

### (1) Stretching in Traveling Direction

In the production method of the invention, preferably, the web is stretched in the traveling direction while being conveyed. In this, the draw ratio of stretching the web is preferably from 5 to 100% from the viewpoint of preventing the web from breaking while attaining a high stretching draw ratio, more preferably from 10 to 80%, even more preferably from 20 to 50%. The draw ratio (elongation) in stretching the cellulose acylate web can be achieved by the peripheral speed difference between the metal support speed and the peeling speed (peeling roll draw). For example, in case where an apparatus with two nip rolls is used, the rotation speed of the nip roll on the inlet side is higher than the rotation speed of the nip roll on the outlet side, whereby the cellulose acylate film can be favorably stretched in the traveling direction (machine direction). Thus stretched, the retardation expressibility of the film can be controlled.

“Draw ratio (%)” as referred to herein is computed according to the following formula:

Draw Ratio (%)=100×{(length after stretching)−(length before stretching)}/(length before stretching).

(2) Stretching in Oblique Direction by about 45 Degrees to Traveling Direction

In the production method of the invention, preferably, the web is, while conveyed, stretched in an oblique direction by about 45 degrees to the traveling direction. In this, the draw ratio of the web is preferably from 5 to 100% from the viewpoint of preventing the web from breaking while attaining a high stretching draw ratio, more preferably from 10 to 80%, even more preferably from 20 to 50%.

The method of stretching in an oblique direction by about 45 degrees to the film traveling direction is described, for example, in JP-T 2005-51321.

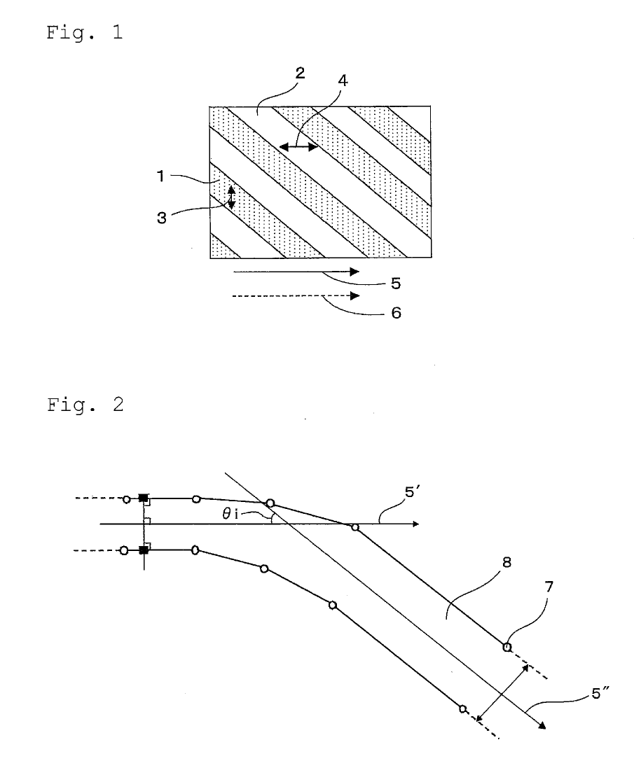

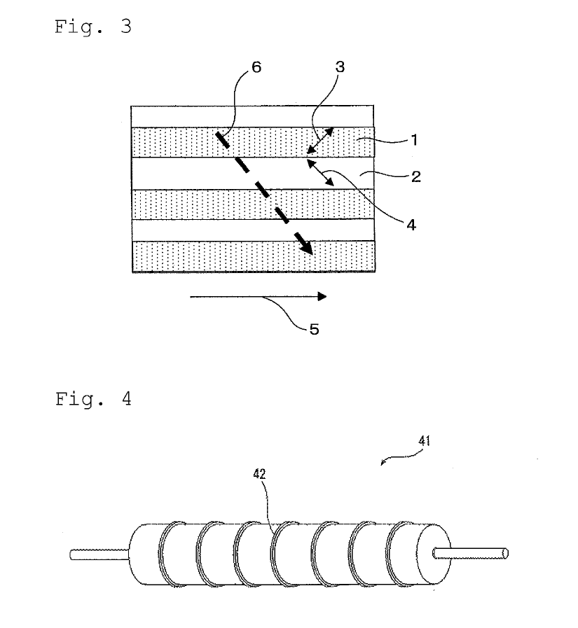

An embodiment of stretching in an oblique direction by about 45 degrees to the film traveling direction, which is preferred for use in the production method of the invention, is described with reference to FIG. 2. First, the film conveyed in the traveling direction 5′ before stretched in an oblique direction is further conveyed while held with a pin tenter 7 at both sides thereof, and using a rail pattern settled so that the film could be finally conveyed in the traveling direction 5″, the tenter width is gradually broadened as in FIG. 2 to thereby stretch the film in an oblique direction. In this, the angle θi between the traveling direction 5′ before stretching and the traveling direction 5″ after stretching is the stretching angle. In the production method of the invention, the oblique stretching angle is preferably from 40 degrees to 50 degrees, more preferably from 43 degrees to 47 degrees, even more preferably from 44 degrees to 46 degrees. In this, by varying the moving speed of the pin tenter 7, the draw ratio in the oblique direction by about 45 degrees can be favorably controlled.

“Draw ratio (%)” in the oblique direction as referred to herein means the value computed according to the following formula in which (a) indicates the difference between two points before stretching and (b) indicates the difference between two points after stretching.

Draw ratio (%)=(b−a)/a×100.

In the stretching step in the invention, the surface temperature of the web being stretched (stretching temperature) is, though not specifically defined, preferably 30° C. or lower from the viewpoint of energy efficiency. The web stretching speed in the stretching speed is, also though not specifically defined, preferably from 1 to 1000%/min from the viewpoint of the stretchability (wrinkling resistance, handleability) of the web, more preferably from 1 to 100%/min. The stretching may be single-stage stretching or multi-stage stretching. In addition, the web may be further stretched also in the direction perpendicular to the traveling direction (lateral direction).

After the stretching step, the web is subsequently conveyed into a drying zone, in which the web may be processed in a drying step after the stretching step. In the drying step, the web is dried, while clipped on both sides or conveyed with rolls.

The drying temperature in the drying step is preferably lower than the film surface temperature that rises in the heating step where a partial region of the film is heated as mentioned below. In particular, by drying the film at a temperature lower than the film surface temperature at which the slow axis formed by stretching the entire film could not rotate by 45 degrees or more, the slow axis in the region to be not heated in the heating step of heating a partial region of the film to be mentioned below is not rotated and the second region is thereby formed. For example, as in the embodiment of Examples shown herein, when the film is dried at 140° C. for 10 minutes in a tenter, the film surface temperature in the drying step is lower than 120° C.

After stretched, the web may be directly conveyed in the heating step for heating a partial region of the film; or after the stretched film is once wound up, and then the unwounded film may be processed in the heating step for heating a partial region of the film in an off-line processing mode. The preferred width of the cellulose acylate film before the partial region heating step is from 0.5 to 5 m, more preferably from 0.7 to 3 m. In case where the stretched film is once wound up, the preferred length of the wound-up roll is from 300 to 30000 m, more preferably from 500 to 10000 m, even more preferably from 1000 to 7000 m.

### (Partial Region Heating Step)

In the production method for an optical film of the invention includes a step of heating a partial region of the stretched film in such a manner that the slow axis formed by stretching in the partial region could rotate by at least 45 degrees (hereinafter this may be referred to as a partial region heating step). In this, the partial step of the stretched film which is so heated that the slow axis formed by stretching therein could rotate by at least 45 degrees is to correspond to the first region of the film of the invention. The remaining region of the stretched film which is not heated and in which, therefore, the slow axis formed by stretching therein does not rotate by 45 degrees or more is to correspond to the second region of the film of the invention.

In the invention, a partial region of a cellulose acylate film that has been stretched in a specific direction as a whole is so heated that the slow axis formed by the stretching in the partial region could rotate by at least 45 degrees, whereby in the heated region, the retardation expression direction can be greatly varied while the absolute value of the retardation therein is kept as such, and on the other hand, the absolute value of the retardation in the non-heated region and the expression direction thereof in the non-heated region can be kept as such. Accordingly, the film of the invention can form the first region (heated region) and the second region (non-heated region) differing from each other in birefringence in one and the same sheet thereof, and therefore the surface condition of the film of the invention is better than that of a conventional patterned retardation film produced by the use of an adhesive or a bond.

Further, in the invention, while the absolute value of the retardation in the heated region is kept as such, the expression direction thereof can be significantly varied, but the alignment direction of the cellulose acylate molecules in the heated region does not vary throughout the entire process before and after the heat treatment. Accordingly, in the film of the invention, the alignment direction of the cellulose acylate to constitute the first region (heated region) and the alignment condition of the cellulose acylate to constitute the second region (non-heated region), the two regions differing from each other in birefringence, do not change throughout the entire process before and after the heat treatment. Accordingly, as compared with a conventional patterned retardation film that is produced by changing the absolute value of the retardation in a partial region of one sheet of film through change or complete erasure of the alignment direction of the polymer constituting the film, the film produced according to the production method of the invention can have a bettered surface condition since the alignment direction of the cellulose acylate molecules are not disordered inside the film.

The partial region heating step is described below.

In the production method of the invention, a partial region of a stretched film is so heated that the slow axis formed by stretching in the partial region could rotate by at least 45 degrees. The heating is preferably such that the slow axis formed by stretching in the partial region could rotate by about 90 degrees (from 88 to 92 degrees, preferably from 89 to 91 degrees, more preferably 90 degrees) to attain slow axis inversion. Concretely, though depending on the total degree of acyl substitution of the cellulose acylate resin to be used, the film surface temperature may be elevated up to 120° C. or higher, as in the embodiment of Examples given herein, whereby the slow axis could rotate by about 90 degrees.

In the production method of the invention, the heating means for heating a partial region of the stretched film in such a manner that the slow axis formed by stretching in the partial region could rotate by at least 45 degrees is not specifically defined, for which, for example, employable is thermal energy irradiation or contact heating with a corrugated hot roller of which the surface is corrugated so that the corrugated surface of the roller could be kept in contact with a partial region of the film surface.

In the partial region heating step, preferably, the film surface temperature in the partial region of the stretched film is at least 80° C. or higher from the viewpoint of slow axis inversion, more preferably 120° C. or higher. On the other hand, from the viewpoint of not erasing the retardation in the partial region of the film by heating, the film surface temperature is preferably not higher than 300° C., more preferably not higher than 250° C., even more preferably not higher than 230° C.

In the production method of the invention, the thermal energy irradiation method is not specifically defined, for which is employable any known method. For example, there are mentioned IR laser irradiation, UV irradiation, etc. In the production method of the invention, preferred is IR laser irradiation from the viewpoint of the latitude in patterning.

Regarding the wavelength of the IR laser, any of near IR, middle IR or far IR wavelength may be employed here; and above all, preferred is use of near IR wavelength laser. The near IR laser includes, for example, YAG laser (wavelength 1064 nm). The far IR laser includes, for example, carbon dioxide laser (wavelength 10600 nm).

In the production method for an optical film of the invention, the timing of the partial region heating step is not specifically defined so far as the step is after the stretching step. For example, the heating step may be attained immediately after the stretching step, or may be attained after a drying step that is attained after the stretching step.

On the other hand, in the production method for an optical film of the invention, preferably, the partial region is heated while the stretched film contains the solvent in an amount of at least 3%. This is because, in this embodiment, slow axis conversion can be attained at a lower heating temperature to the same level as that in the other case where the heating is attained in the absence of solvent in the film. More preferably, while the stretched film contains the solvent in an amount of from 40 to 5%, the partial region heating step is attained; and even more preferably, while the stretched film contains the solvent in an amount of from 20 to 5%, the partial region heating step is attained.

In the production method for an optical film of the invention, preferably, the partial region heating is for a part of the stripe regions of the stretched film from the viewpoint of producing a patterned retardation film for 3D stereoscopic image display, and more preferably a part of the stripe regions of the stretched film are irradiated with thermal energy.

In the production method for an optical film of the invention, preferably, the partial region heating is for forming at least two stripe regions of a first stripe region which is so heated that the slow axis formed by stretching therein could rotate by at least 45 degrees and a second stripe region which is not heated and in which, therefore, the slow axis formed by stretching therein does not rotate by 45 degrees or more. More preferably, the stretched film is irradiated with thermal energy so as to form at least two stripe regions of a first stripe region irradiated with thermal energy and a second stripe region not irradiated with thermal energy.

Also preferably, the width (short side) of the stripe region, or that is, the short side of the first region of the film of the invention is nearly equal to the line width of the desired 3D stereoscopic image display panel.

Similarly, the width (short side) of the second stripe region, or that is, the short side of the second region of the film of the invention is nearly equal to the line width of the desired 3D stereoscopic image display panel. In other words, in the production method for an optical film of the invention, preferably, the length of the short side of the first stripe region is nearly equal to the length of the short side of the second stripe region.

On the other hand, the long side of the stripe region is not defined irrespective of the panel size for 3D stereoscopic image display, or that is, the film of the invention can be produced continuously in any manner where the length thereof could be on the same level as that in ordinary continuous film formation of cellulose acylate films. Accordingly, in the production method of the invention, a long film may be produced continuously, then cut into a size for 3D stereoscopic image display panels, and can be used as a patterned retardation film for 3D stereoscopic image display, and therefore the production cost for the film is low.

In the production method for an optical film of the invention, preferably, the partial region in which the slow axis formed by stretching has rotated by at least 45 degrees is heated in such a manner that the long side of the stripe region could be at around 45 degrees to the stretching direction, from the viewpoint of producing a patterned retardation film for 3D stereoscopic image display in an ordinary polarized glasses system (a mode of conversion from linear polarization into circular polarization).

Specifically, in case where the film is stretched in the film traveling direction in the stretching step, the stripe region to be so heated that the slow axis formed by the stretching therein could rotate by at least 45 degrees is preferably in the direction of about 45 degrees to the film traveling direction. In case where the film is stretched in an oblique direction by 45 degrees relative to the film traveling direction in the stretching step, the stripe region to be so heated that the slow axis formed by the stretching therein could rotate by at least 45 degrees is preferably in the film traveling direction.

FIG. 1 shows one preferred embodiment of the optical film of the invention, which is produced in a case of stretching in the film traveling direction in the stretching step and in which the stripe region to be so heated that the slow axis formed therein by the stretching could rotate by at least 45 degrees is in the direction of about 45 degrees relative to the film traveling direction.

FIG. 2 show a preferred positional embodiment of the optical film of the invention in a case where the film is stretched obliquely at 45 degrees relative to the film traveling direction in the stretching step and where the stripe region to be so heated that the slow axis formed therein by the stretching could rotate by a least 45 degrees is in the film traveling direction.

From FIG. 1 and FIG. 2, it is known that, when the film is so heated that the slow axis formed by the stretching could rotate by at least 45 degrees and that the long side of the stripe region could be at about 45 degrees relative to the stretching direction, then an optical film, in which the first region and the second region are stripe ones and in which the angle between the long side direction of the stripe region and the alignment direction of the polymers constituting the first region and the second region that are substantially in the same direction is about 45 degrees, can be obtained.

As the equipment for thermal irradiation of the stretched cellulose film, serving as the heating means for the partial region therein mentioned above, there are mentioned laser scanning systems with laser array, polygon mirror, etc.

On the other hand, as an apparatus for contact heating with a roller of which the surface is so corrugated that the surface could be partly kept in contact with the partial region of the surface of the stretched cellulose film, serving as the heating means for the partial region in the film, there is mentioned a corrugated roller of which the surface is corrugated to have a specific configuration. Concretely, the corrugated roller 41 is, as shown in FIG. 4, a roller of which the peripheral surface is specifically so corrugated as to have multiple stripe corrugations 42 thereon, in which the dimension of each corrugation 42 and the distance between the neighboring corrugations 42 may be controlled so as to control the width between the first region and the second region. Specifically, the range of the pitch width of the corrugations 42 is the same as the range of the width of the second region (the width of the region sandwiched between the above-mentioned two first regions). In case where the partial region of the stretched film is heated with the corrugated roller 41, preferably, the corrugated roller 41 is kept in contact with the stretched film and the corrugated roller 41 is moved while rotated, whereby the partial region of the stretched film is heated via the corrugations 42 of the corrugated roller 41. The flat part with no corrugation of the corrugated roller 41 is kept so as not to be in contact with the stretched film, whereby only the partial region in which the slow axis formed by stretching rotates by at least 45 degrees can be heated. Using the corrugated roller of the type facilitates the heating of the partial stripe region of the stretched film. In place of the corrugated roller, a partial region of the stretched film may also be heated by the use of a corrugated press; however, from the viewpoint of continuous production and of improving the surface condition of the film, preferred is use of the corrugated roller.

In case where the stretched film is so irradiated with thermal energy that the stripe region thereof to be irradiated therewith could be in the direction of about 45 degrees relative to the film traveling direction, preferably, the film is irradiated with IR laser concretely through laser scanning with laser array, polygon mirror, etc.

On the other hand, in case where the film is so irradiated with thermal energy that the stripe region thereof to be irradiated therewith could be in the film traveling direction, concretely, an IR laser generation apparatus is installed as fixed in accordance with the distance corresponding to the width of each region of the desired patterned retardation film (width of the first region and the width of the second region of the film of the invention), and the film is irradiated with the apparatus while so controlled that the IR laser irradiation diameter on the film surface could be equal to the above-mentioned with.

[Cooling of Partial Region after Heating Step]

After the thermal irradiation step, preferably, the polymer film (web) is rapidly cooled immediately after the step from the viewpoint of preventing the thermal conduction from the first stripe region heated in the partial region heating step to the second stripe region not heated in the heating step.

In this, the film is cooled while conveyed under a conveyance tension of from 0.1 to 500 N/m, whereby the humidity dependence of the retardation (especially Re) of the finally obtained cellulose acylate film can be effectively reduced. The conveyance tension in cooling is preferably from 1 to 400 N/m, more preferably from 10 to 300 N/m, even more preferably from 50 to 200 N/m. When the conveyance tension is at least 0.1; N/m, then the humidity dependence of retardation can be reduced and the surface condition of the film could be more bettered. When the conveyance tension is at most 500 N/m, then the humidity dependence of retardation can be reduced and the absolute value of Re could be increased with ease.

The cooling speed in cooling is not specifically defined. Preferably, the film is cooled at a rate of from 100 to 1,000,000° C./min, more preferably from 1,000 to 100,000° C./min, even more preferably from 3,000 to 50,000° C./min. The temperature width in which the film is cooled at such a cooling speed is preferably at least 50° C., more preferably from 100 to 300° C., even more preferably from 150 to 280° C., still more preferably from 180 to 250° C.

By controlling the cooling speed in the manner as above, the retardation expressibility of the obtained cellulose acylate film can be controlled more favorably. Concretely, when the cooling speed is increased, the retardation expressibility can be increased. In addition, the alignment distribution of the polymer chains in the thickness direction of the cellulose acylate film can be attenuated, and the film can be prevented from curling by moisture. The effect can be more fully attained when the temperature width for cooling the film at a relatively high cooling speed is controlled to fall with the above-mentioned preferred range.

The cooling speed can be controlled by providing, after the heating zone, a cooling zone in which the temperature is kept lower than that in the heating zone, and sequentially conveying the cellulose acylate film through those zones, or by bringing a cooling roll into contact with the film, or by spraying cooling water onto the film, or by dipping the film in a cold liquid. It is not necessary that the cooling speed is always constant during the cooling step, but the cooling speed may be low in the initial stage and the final stage of the cooling step while the cooling speed may be high between those stages. The cooling speed may be determined by measuring the temperature at different points of the film surface by the use of a thermocouple set above the film, as described in Examples given hereinunder.

The film thickness may be controlled by controlling the solid concentration in the dope, the slit aperture of the die mouth, the extrusion pressure through the die, the metal support speed and the like in order that the produced film could have a desired thickness.

### (Winding)

Produced in the manner as above, the length of the optical film of the invention to be wound up is preferably from 100 to 10000 m per roll, more preferably from 500 to 7000 m, even more preferably from 1000 to 6000 m. The width of the optical film is preferably from 0.5 to 5.0 m, more preferably from 1.0 to 3.0 m, even more preferably from 1.0 to 2.5 m. In winding the film, preferably, at least one side thereof is knurled, and the knurling width is preferably from 3 mm to 50 mm, more preferably from 5 mm to 30 mm, and the knurling height is preferably from 0.5 to 500 μm, more preferably from 1 to 200 μm. This may be one-way or double-way knurling.

The film of the invention is suitable especially for use in large-panel liquid-crystal display devices. In case where the film is used as the optical compensatory film in large-panel liquid-crystal display devices, for example, the film is shaped preferably to have a width of at least 1470 mm. The optical compensatory film of the invention includes not only film sheets cut to have a size that may be directly incorporated in liquid-crystal display devices but also long films continuously produced and rolled up into rolls. The optical compensatory film of the latter embodiment is stored and transported in the rolled form, and is cut into a desired size when it is actually incorporated into a liquid-crystal display device or when it is stuck to a polarizing element or the like. The long film may be stuck to a polarizing element formed of a long polyvinyl alcohol film directly as it is long, and then when this is actually incorporated into a liquid-crystal display device, it may be cut into a desired size. One embodiment of the long optical compensatory film rolled up into a roll may have a length of 2500 m/roll or more.

### [Polarizer]

The polarizer of the invention comprises at least one optical film of the invention as laminated therein.

The polarizer may have any known ordinary configuration, and the concrete configuration of the polarizer is not specifically defined. In the invention, any known polarizer configuration is employable with no limitation. For example, the constitution of FIG. 6 in JP-A 2008-262161 is employable here. The optical film of the invention may be laminated on one surface of an ordinary polarizer to give a patterned retardation film for use in polarized-glasses-assisted 3D stereoscopic image display systems. The embodiment of the polarizer includes not only film sheets cut to have a size that may be directly incorporated in liquid-crystal display devices but also long films continuously produced and rolled up into rolls (for example, an embodiment having a roll length of 2500 m or more, or 3900 m or more). For use in large-panel liquid-crystal display devices, the width of the polarizer is preferably at least 1470 mm as so mentioned in the above.

### [Production Method for Polarizer]

The production method for the polarizer of the invention comprises a step of stretching the entire film containing a cellulose acylate in a direction oblique to the film traveling direction by about 45 degrees, a step of heating the stretched film in such a manner that the slow axis formed by the stretching could rotate by at least 45 degrees relative to the stripe region of a part of the stretched film of which the long side is in the film conveying direction, thereby forming at least two regions of a first stripe region which has been heated such that the slow axis therein formed by stretching is rotated by at least 45 degrees and a second stripe region which has not been heated such that the slow axis therein formed by stretching is rotated by at least 45 degrees, and a step of laminating the resulting optical film on a belt-like polarizer of which the transmission axis is at the width direction thereof, in a mode of roll-to-roll lamination.

Having the constitution as above, the polarizer production method of the invention enables continuous production and therefore reduces the production cost as compared with that in conventional production methods. In addition, in case where the stretching direction is obliquely at about 45 degrees relative to the film traveling direction, then it is unnecessary to obliquely blank the polarizer produced as a roll, and the production cost in polarizer production can be thereby lowered.

### [Image Display Panel]

The image display panel of the invention contains at least one optical film of the invention. Of the light from the panel, the polarization state of the light having passed through the first region and that of the light having passed through the second region can be varied, therefore realizing an image display panel for 3D stereoscopic image display.

Not specifically defined, the image display panel for use in the image display device of the invention may be any of CRT or flat panel display, but preferred is flat panel display. As the flat panel display, herein usable are PDP, LCD, organic ELD, etc. The invention is especially preferred for liquid-crystal image display panels. The liquid-crystal image display panel to which the invention is applied realizes high-quality and inexpensive image display systems of flat panel displays.

The liquid-crystal display device of the invention comprises a liquid-crystal cell and a pair of polarizers disposed on both sides of the liquid-crystal cell, in which at least one polarizer is the polarizer of the invention. Preferably, the liquid-crystal display device of the invention is an IPS, OCB or VA-mode liquid-crystal display device.

The concrete configuration of the liquid-crystal display device is not specifically defined, for which is employable any known configuration. The configuration shown in FIG. 2 in JP-A 2008-262161 is also preferably employed here.

### [Image Display System]

The image display system of the invention comprises at least one optical film of the invention. Accordingly, a left-eye image and a right-eye image may be inputted into the image display panel, and the left-eye image and the right-eye image may be ejected from the image display panel toward the optical film of the invention whereupon the polarization state of the left-eye image (or right-eye image) having passed through the first region of the optical film of the invention and that of the right-eye image (or left-eye image) having passed through the second region thereof can be changed. Further using polarized glasses having a left-eye lens fitted with a polarizer capable of transmitting only the left-eye image having passed through the first region and a right-eye lens fitted with a polarizer capable of transmitting only the right-eye image having passed through the second region realizes an image display system for 3D stereoscopic image display observation in which the left-eye image and the right-eye image are individually led to hit on the left and right eyes, respectively.

The image display system of the type is described in U.S. Pat. No. 5,327,285. Examples of polarized glasses are described in JP-A 10-232365.

The patterned retardation film may be peeled off from a commercial image display system and the optical film of the invention may be incorporated into the system in place of the removed film; and for example, an image display device of Zalman's ZM-M240W (trade name) may be used.

### EXAMPLES

The invention is described more concretely with reference to the following Examples. In the following Examples, the materials used, their amount and ratio, the details of the treatment and the treatment process may be suitably modified or changed not overstepping the spirit and the scope of the invention. Accordingly, the invention should not be limited to the Examples mentioned below.

In the invention, the samples were analyzed according to the following measurement methods.

### (Optical Expressibility)

Each sample was analyzed for Re and Rth thereof at a wavelength of 590 nm, according to the above method and using KOBRA 21ADH (by Oji Scientific Instruments). The results are shown in Table 1 below.

### (Direction of Slow Axis)

Each sample was analyzed for the direction of slow axis thereof according to the above method and using KOBRA 21ADH (by Oji Scientific Instruments). The results are shown in Table 1 below.

### Example 1

### Preparation of Polymer Solution

In a 400-1 stainless dissolver tank having a stirring blade and kept cooled with cooling water running around the outer circumference thereof, the following solvents (first to third solvents) and additive were put, and while these were stirred and dispersed, the following cellulose acylate was gradually added thereto. After the addition, this was stirred at room temperature for 2 hours and kept swollen for 3 hours, and then again stirred.

For the stirring, used were a dissolver-type eccentric stirring shaft for stirring at a peripheral speed of 15 m/sec (shearing stress 5×10⁴ kgf/m/sec^{2 [}4.9×10⁵ N/m/sec²]) and a stirring shaft having an anchor blade as the center shaft thereof for stirring at a peripheral speed of 1 m/sec (shearing stress 1×10⁴ kgf/m/sec^{2 [}9.8×10⁴ N/m/sec²]). The mixture was swollen by stopping the high-speed stirring shaft and changing the peripheral speed of the anchor blade-having stirring shaft to 0.5 m/sec.

From the tank, the swollen solution was heated up to 50° C. with a jacketed pipe line, and further heated up to 90° C. under pressure of 2 mPa for complete dissolution. The heating time was 15 minutes. During this, the filter, the housing and the pipeline to be exposed to high temperatures were formed of Hastelloy alloy and had excellent corrosion resistance. These were jacketed for a heat carrier to run through the jacket for heating.

Next, this was cooled to 36° C., and the resulting solution was filtered through a paper filter having an absolute filtration accuracy of 10 μm (#63, by Toyo Roshi), and further through a metal sintered filter having an absolute filtration accuracy of 2.5 μm (FH025, by Paul) to give a polymer solution.

Composition of Cellulose Acylate Solution A (Example 1)

| | | |
|---|---|---|
| Cellulose acylate having a degree of acetyl | 100 | parts by mass |
| substitution of 2.94 | | |
| Methylene chloride (first solvent) | 475.9 | parts by mass |
| Methanol (second solvent) | 113.0 | parts by mass |
| Butanol (third solvent) | 5.9 | parts by mass |
| Silica particles having a mean particle size of | 0.13 | parts by mass |
| 16 nm (AEROSIL R972, by Nippon Aerosil) | | |
| Optical anisotropy controlling agent | 10.0 | parts by mass |
| (Compound AA mentioned above) | | |
| UV agent (Compound AB mentioned above) | 7.0 | parts by mass |
| IR absorbent (Compound AD mentioned below) | 0.5 | parts by mass |
| Citrate (Compound AE mentioned below) | 0.01 | parts by mass |

Compound AD: diimmonium salt, KAYASORB IRG-022 (by Nippon Kayaku, λmax = 1100 nm)
[Chemical Formula 3] 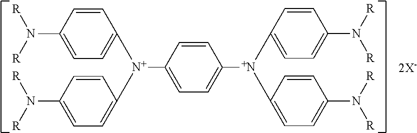
Compound AE: mixture of the following (1) and (2) ((1) is the main ingredient)
[Chemical Formula 4]
(1) 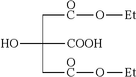
(2)

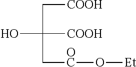

### <Casting Step>

The polymer solution was heated at 30° C., and cast on a mirror-surface stainless support of a drum having a diameter of 3 m, through a casting Giesser, thereby forming a web thereon. The temperature of the support was set at −9° C., and the coating width was 200 cm. The spatial temperature in the entire casting zone was set at 15° C. At the point of 50 cm before the endpoint of the casting zone, the web that had been cast and rotated was peeled away from the drum. In the peeled web, the residual solvent amount was about 270%. The residual solvent amount was controlled by controlling the casting speed (drum revolution speed).

### <Stretching Step>

Both sides of the peeled web were held with a pin tenter, and the web was stretched by 30% in the traveling direction. The draw ratio in stretching was controlled by controlling the tenter traveling speed, and the roller revolution speed between the drum and the tenter.

After stretched, the web held by the pin tenter was conveyed into a drying zone. First, the web was dried with dry water at 45° C., and then at 110° C. for 5 minutes and further at 140° C. for 10 minutes.

### <Patterning Step>

Both sides of the stretched web were clipped with a tenter clip, and then in the drying step at 110° C. for 5 minutes and at 140° C. for 10 minutes, the web was dried until the residual solvent amount in the dried web could be within a range of from 15 to 5%. Then, using a YAG laser (1064 nm), this was heated so that the surface temperature could reach 120° C., and then in the direction at 45 degrees relative to the traveling direction, the film was heated at an irradiation width of 200 μm and at a pitch of 200 μm.

Thus obtained, the optical film of Example 1 had a thickness of 140 μm, a width of 1500 mm, a length of 3500 m. The obtained film was analyzed for the optical properties thereof according to the above-mentioned methods. In this, the laser non-irradiated part (first region) formed at a pitch of 200 μm in the film traveling direction had a retardation of 140 nm expressed in the stretching direction, and the laser irradiated part (second region) had a retardation of 140 nm expressed in the direction perpendicular to the stretching direction. Specifically, based on the patterning direction of the first region and the second region (short side direction of each stripe region), λ/4 and −λ/4 expression was found. The results are shown in Table 1 and FIG. 1.

### Examples 2 to 4, 7, 8 and Comparative Example 1

Films of other Examples were produced in the same manner as in Example 1 except that the items shown in Table 1 were changed as in the Table.

On the other hand, in Comparative Example 1, 100 parts by weight of PVA (having a degree of polymerization of 1750 and a degree of saponification of 99.9 mol %) was mixed with water to prepare a homogeneous solution having a water content of 60% by weight, and using a belt-type casting machine, the solution was cast and dried at 150° C. In this, the film was stretched at 35° C. in water and the other conditions were the same as in Example 1 except those indicated in Table 1, thereby producing a film of Comparative Example 1 having a thickness of 75 μm.

The dimensions of the optical films of Examples and Comparative Example are the same as those of the optical film of Example 1 except for the data shown in Table 1 below. The optical films of Examples and Comparative Example were analyzed for the optical properties thereof according to the above-mentioned methods, and the results are shown in Table 1 below.

Further, in the same manner as in Example 1, the optical film of Examples and Comparative Example was incorporated in a polarizer and a liquid-crystal display device, thereby producing liquid-crystal display devices of Examples and Comparative Example.

### Examples 5, 9 and 10

Films were produced as a roll in the same manner as in Examples 1, 4 and 3 except that the stretching step in Examples 1, 4 and 3 was changed to the oblique stretching step mentioned below. Subsequently, the films were patterned in the same manner as in these Examples except that the laser thermal irradiation direction was changed from the direction at 45 degrees relative to the film traveling direction, into the film traveling direction, thereby producing optical films of Examples 5, 9 and 10. Thus obtained, the optical films of Examples 5, 9 and 10 were uniform in the direction perpendicular to the film traveling direction after the oblique stretching. The optical films of Examples 5, 9 and 10 were analyzed for the optical properties thereof according to the above-mentioned methods, and the results are shown in Table 1 below.

### <45-Degrees Oblique Stretching Step>

The peeled web was held at both sides thereof with a pin tenter, introduced into a tenter of which the rail pattern was so settled that the angle in FIG. 2, θi=47°, and stretched in an oblique direction so that the alignment angle θ could be 45°. The stretched film was so controlled that the take-up tension fluctuation could be less than 3% in a mode of feedback control of reflecting the fluctuation of the tension measured by the upstream side roll, onto the revolution number of the take-up motor. Afterwards, both sides of the film were trimmed by 250 mm, thereby giving a roll of a long, oblique-stretched optical film having a width of 1340 mm.

### Example 11

An optical film of Example 11 was produced in the same manner as in Example 9 except that a metal roll having a 200-μm pitch corrugation on the surface thereof, as described in JP-A 2005-37736, was used in place of the laser irradiation in Example 9, and the film was line-wise heated in the film traveling direction so that the film surface temperature could be 120° C. Thus obtained, the optical film of Example 11 was uniform in the direction perpendicular to the film traveling direction after the oblique stretching. The optical film of Example 11 was analyzed for the optical properties thereof according to the above-mentioned methods, and the results are shown in Table 1 below.

### Example 6

An optical film of Example 6 was produced in the same manner as in Example 1 except that the patterning step in Example 1 was changed to the following patterning step.

### <Patterning Step in Example 6>

The stretched web was held on both sides thereof with a tenter clip, and dried until the residual solvent amount in the film could reach at most 1%. Subsequently, the film was heated with an IR laser so that the surface temperature thereof could reach 220° C., and then in the direction at 45 degrees relative to the traveling direction, the film was heated at an irradiation width of 200 μm and at a pitch of 200 μm.

Thus obtained, the film had a thickness of 140 μm, a width of 1500 mm and a length of 3500 m, and expressed a retardation of λ/4 and −λ/4 at a pitch of 200 μm.

The optical film of Example 6 was analyzed for the optical properties thereof according to the above-mentioned methods, and the results are shown in Table 1 below.

TABLE 1

| | Film Production Method | | | | | | | | | | | | |
|---|---|---|---|---|---|---|---|---|---|---|---|---|---|
| | Casting Step | | | | | | | | | | | Thermal Irradiation Step | |
| | Dope Composition | | | | | | | | | Stretching Step | | | Long Side |
| | | | Additive having positive | | | | | | | | Stretching | | Direction of |
| | Cellulose Acylate | | intrinsic birefringence | | | | | | | | Direction | | Irradiated |
| | Degree of | Degree of | Plasticize | | UV Agent | | IR Absorbent | | | Draw | relative | | Part relative |
| | Acetyl | Propionyl | | part | | part | | part | Thick- | Ratio in | to film | IR Laser | to film |
| | Substi- | Substi- | | by | | by | | by | ness | stretching | traveling | (wave- | traveling |
| | tution | tution | type | weight | type | weight | type | weight | (μm) | (%) | direction | length) | direction |
| Example 1 | 2.94 | — | AA | 10.0 | AB | 7 | AD | 0.5 | 140 | 30 | 0 | YAG | 45 |
| | | | | | | | | | | | degree | (1064 nm) | degrees |
| Example 2 | 2.94 | — | AA | 10.0 | AC | 8 | AD | 0.5 | 140 | 30 | 0 | YAG | 45 |
| | | | | | | | | | | | degree | (1064 nm) | degrees |
| Example 3 | 2.4 | 0.60 | AA | 15.0 | AC | 8 | AD | 0.5 | 100 | 30 | 0 | YAG | 45 |
| | | | | | | | | | | | degree | (1064 nm) | degrees |
| Example 4 | 2.4 | 0.60 | AA | 15.0 | AC | 8 | — | — | 100 | 30 | 0 | carbon | 45 |
| | | | | | | | | | | | degree | dioxide | degrees |
| | | | | | | | | | | | | (10600 nm) | |
| Example 5 | 2.94 | — | AA | 10.0 | AB | 7 | AD | 0.5 | 140 | 30 | 45 | YAG | 0 |
| | | | | | | | | | | | degrees | (1064 nm) | degree |
| Example 6 | 2.94 | — | AA | 10.0 | AB | 7 | AD | 0.5 | 140 | 30 | 0 | YAG | 45 |
| | | | | | | | | | | | degree | (1064 nm) | degrees |
| Example 7 | 2.94 | — | AA | 10.0 | — | — | AD | 0.5 | 140 | 30 | 0 | YAG | 45 |
| | | | | | | | | | | | degree | (1064 nm) | degrees |
| Example 8 | 2.94 | — | — | — | AB | 7 | AD | 0.5 | 140 | 30 | 0 | YAG | 45 |
| | | | | | | | | | | | degree | (1064 nm) | degrees |
| Example 9 | 2.4 | 0.60 | AA | 15.0 | AC | 8 | — | — | 100 | 30 | 45 | carbon | 0 |
| | | | | | | | | | | | degrees | dioxide | degree |
| | | | | | | | | | | | | (10600 nm) | |
| Example 10 | 2.4 | 0.60 | AA | 15.0 | AC | 8 | AD | 0.5 | 100 | 30 | 45 | YAG | 0 |
| | | | | | | | | | | | degrees | (1064 nm) | degree |
| Example 11 | 2.4 | 0.60 | AA | 15.0 | AC | 8 | — | — | 100 | 30 | 45 | — | — |
| | | | | | | | | | | | degrees | | |
| Comparative | — | — | — | — | — | — | — | — | 75 | 20 | 0 | YAG | 45 |
| Example 1 | | | | | | | | | | | degree | (1064 nm) | degrees |

| | Film Properties | | | | | | |
|---|---|---|---|---|---|---|---|
| | Optical Characteristics | | | | | | |
| | | | | Second Region | | | Angle between |
| | First Region | | | (irradiated region) | | | the slow axis |
| | (non-irradiated region) | | | | slow axis direction | polymer alignment | in the first |
| | | Stretching Direction | polymer alignment | | relative to | direction relative to | region and the |
| | Re | relative to film | direction relative to | Re | film traveling | film traveling | slow axis in |
| | (nm) | traveling direction | film traveling direction | (nm) | direction | direction | the second region |
| Example 1 | 140 | 0 | 0 | 140 | 90 | 0 | 90 |
| | | degree | degree | | degrees | degree | degrees |
| Example 2 | 110 | 0 | 0 | 170 | 90 | 0 | 90 |
| | | degree | degree | | degrees | degree | degrees |
| Example 3 | 100 | 0 | 0 | 200 | 90 | 0 | 90 |
| | | degree | degree | | degrees | degree | degrees |
| Example 4 | 120 | 0 | 0 | 140 | 90 | 0 | 90 |
| | | degree | degree | | degrees | degree | degrees |
| Example 5 | 140 | 45 | 45 | 140 | 45 | 45 | 90 |
| | | degrees | degrees | | degrees | degrees | degrees |
| Example 6 | 140 | 0 | 0 | 140 | 90 | 0 | 90 |
| | | degree | degree | | degrees | degree | degrees |
| Example 7 | 40 | 0 | 0 | 240 | 90 | 0 | 90 |
| | | degree | degree | | degrees | degree | degrees |
| Example 8 | 90 | 0 | 0 | 190 | 90 | 0 | 90 |
| | | degree | degree | | degrees | degree | degrees |
| Example 9 | 125 | 45 | 45 | 140 | −45 | 45 | 90 |
| | | degrees | degrees | | degrees | degrees | degrees |
| Example 10 | 95 | 45 | 45 | 195 | −45 | 45 | 90 |
| | | degrees | degrees | | degrees | degrees | degrees |
| Example 11 | 120 | 45 | 45 | 140 | −45 | 45 | 90 |
| | | degrees | degrees | | degrees | degrees | degrees |
| Comparative | 150 | 0 | 0 | 130 | 0 | 0 | 0 |
| Example 1 | | degree | degree | | degree | degree | degree |

From Table 1, it is known that, in the optical films of Examples 1 to 11, the angle between the slow axis of the first region and the slow axis of the second region is 90 degrees. On the other hand, it is known that, in Comparative Example 1, the angle between the slow axis of the first region and the slow axis of the second region is 0 degree and oversteps the scope of the optical film of the invention. In addition, it is known that the film of Comparative Example 1 could not express sufficient retardation.

### Example 101

### Sticking with Polarizer

A long polarizer having a transmission axis in the width direction thereof was stuck to the long, stretched optical film of Example 1 in a mode of roll-to-roll sticking process, thereby producing a roll of a polarizer having the optical film of Example 1 laminated thereto and having a width of 1340 mm. From the roll, a polarizer of Example 101 was cut out in such a manner that each side of the polarizer could be in an oblique direction at 45 degrees relative to the machine direction of the optical film.

Thus obtained, in the polarizer of Example 101, the long side of the patterned first region and second region was nearly parallel to the long side of the polarizer.

### <Mounting on Liquid-Crystal Display Device and Evaluation of the Device>

The polarizer of Example 101, thus cut out in the manner as above, was replaced for the panel-side polarizer of a commercially-available TN-mode liquid-crystal display device (AL2216W, by Nippon Acer), thereby constructing a liquid-crystal display device of Example 1. In this, the polarizer of Example 101 was so arranged in the device that the side of the optical film of Example 1 of the polarizer could face the opposite side of the liquid-crystal cell. It was confirmed that the width of each region of the recurring retardation pattern of the first region and the second region of the optical film of Example 1 was the same as the width of the line (scanning line) of the liquid-crystal display device.

Image data including a right-eye image and a left-eye image for 3D stereoscopic image display were inputted into the liquid-crystal display device of Example 101. In this, the right-eye image was displayed in the first region and the left-eye image was in the second region. Using polarized glasses for 3D stereoscopic image recognition in which the left-eye lens and the right-eye lens each individually transmit the left-circularly polarized light and the right-circularly polarized light, respectively, the image on the liquid-crystal display device was observed. As a result, a good stereoscopic image was seen.

### Examples 102 to 104, and 106 to 108

Polarizers and liquid-crystal display devices of Examples 102 to 104 and 106 to 108 were produced in the same manner as in Example 101 except that the optical film of Example 1 used in Example 101 was changed to the films of Examples 2 to 4 and 6 to 8, respectively.

In the same manner as in Example 101, a 3D stereoscopic image was inputted into the thus-obtained liquid-crystal display devices and, as a result, it was known that all these devices could provide a good 3D stereoscopic image.

### Examples 105, 109, 110 and 111

### Sticking to Polarizer in Examples 5, 9, 10 and 11

The long optical film of Examples 5, 9, 10 and 11 was stuck to a long polarizer having a transmission axis in the width direction thereof in a mode of roll-to-roll sticking process, thereby producing a roll of a polarizer having the optical film of Examples 5, 9, 10 and 11 laminated thereto and having a width of 1340 mm. From the roll, a polarizer of Examples 5, 9, 10 and 11 was cut out in the film width direction. Thus obtained, in the polarizer of Examples 5, 9, 10 and 11, the long side of the patterned first region and second region was nearly parallel to the long side of the polarizer.

### <Mounting on Liquid-Crystal Display Device and Evaluation of the Device in Examples 5, 9, 10 and 11>

Liquid-crystal display devices of Examples 5, 9, 10 and 11 were constructed in the same manner as in Example 1 except that the polarizer of Example 5, as cut out in the manner as above, was replaced for the panel-side polarizer of a commercially-available VA-mode liquid-crystal display device (Sharp's Model AQUOS LC-20E6(20)) instead of the TN-mode liquid-crystal display device.

In the same manner as in Example 1, 3D stereoscopic image data were inputted into the thus-constructed liquid-crystal display device and evaluated. As a result, the device provided a good 3D stereoscopic image.

### Comparative Example 101

A polarizer and a liquid-crystal display device were produced in the same manner as in Example 101 except that the film of Comparative Example 1 was used in place of the optical film of Example 1.

In the same manner as in Example 1, 3D stereoscopic image data were inputted into the liquid-crystal display device and evaluated. However, the device could not provide a 3D stereoscopic image.

### DESCRIPTION OF REFERENCE NUMERALS AND SIGNS

1 First Region (IR laser irradiated part)
2 Second Region (IR laser non-irradiated part)
3 Slow Axis of First Region
4 Slow Axis of Second Region
5 Film Traveling Direction
5′ Film Traveling Direction before oblique stretching
5″ Film Traveling Direction after oblique stretching
6 Stretching Direction
7 Pin Tenter
8 Film before patterning
41 Corrugated Roller
42 Corrugation

1. An optical film formed of a cellulose acylate and having a first region and a second region that differ from each other in the birefringence, wherein the angle between the slow axis of the first region and the slow axis of the second region is at least 45 degrees.

2. The optical film of claim 1, wherein the composition of the first region is the same as that of the second region.

3. The optical film of claim 1, which is a single-layer film.

4. The optical film of claim 1, wherein the total degree of acyl substitution of the cellulose acylate is from 2.7 to 3.0.

5. The optical film of claim 1, wherein the slow axis of the first region is perpendicular to the slow axis of the second region.

6. The optical film of claim 1, wherein the Re value of all the first region contained in the optical film and the Re value of all the second region contained in the optical film are from 30 to 250 nm, in which Re means the retardation value in the in-plane direction of the film.

7. The optical film of claim 1, wherein the alignment direction of the polymer constituting the first region is substantially the same as the alignment direction of the polymer constituting the second region.

8. The optical film of claim 1, wherein the first region and the second region are stripe ones, and the angle between the long-side direction of the stripe regions and the alignment directions that are substantially the same directions of the polymers constituting the first region and the second region is around 45 degrees.

9. The optical film of claim 1, which contains a compound having a positive intrinsic birefringence.

10. The optical film of claim 1, which contains a compound having IR absorption capability.

11. The optical film of claim 1, wherein the first region and the second region are stripe ones, of which the length of the short side is nearly equal to each other, and are patterned alternately repeatedly.

12. The optical film of claim 1, wherein the boundary between the first region and the second region does not contain an adhesive or a bond.

13. A method for producing an optical film, comprising:
stretching the entire film containing a cellulose acylate in a specific direction and
heating a partial region of the stretched film in such a manner that the slow axis formed by the stretching in the partial region could rotate by at least 45 degrees.

14. The method for producing an optical film of claim 13, wherein the stretching direction is the film traveling direction.

15. The method for producing an optical film of claim 13, wherein the stretching direction is a direction oblique to the film traveling direction by about 45 degrees.

16. The method for producing an optical film of claim 13, wherein the partial region is heated by irradiation with an IR laser.

17. The method for producing an optical film of claim 13, wherein the partial region is heated when the water content in the stretched film is at most 5%.

18. The method for producing an optical film of claim 13, which includes forming the cellulose acylate-containing film in a mode of solution casting.

19. The method for producing an optical film of claim 18, wherein the partial region is heated when the stretched film contains the solvent in an amount of at least 3%.

20. The method for producing an optical film of claim 13, wherein the partial region to be heated is a part of the stripe region of the stretched film.

21. The method for producing an optical film of claim 20, wherein the partial region is so heated that the long side of the stripe region is at about 45 degrees to the stretching direction.

22. The method for producing an optical film of claim 20, wherein the partial region is heated so as to form at least two stripe regions, thereby forming a first stripe region which has been heated such that the slow axis therein formed by stretching is rotated by at least 45 degrees and a second stripe region which has not been heated such that the slow axis therein formed by stretching is rotated by at least 45 degrees.

23. The method for producing an optical film of claim 22, wherein the length of the short side of the first stripe region is nearly the same as the length of the short side of the second stripe region.

24. An optical film produced by:
stretching the entire film containing a cellulose acylate in a specific direction and
heating a partial region of the stretched film in such a manner that the slow axis formed by the stretching in the partial region could rotate by at least 45 degrees.

25. A polarizer laminated with an optical film formed of a cellulose acylate and having a first region and a second region that differ from each other in the birefringence, wherein the angle between the slow axis of the first region and the slow axis of the second region is at least 45 degrees.

26. An image display panel including an optical film formed of a cellulose acylate and having a first region and a second region that differ from each other in the birefringence, wherein the angle between the slow axis of the first region and the slow axis of the second region is at least 45 degrees.

27. An image display system including an optical film formed of a cellulose acylate and having a first region and a second region that differ from each other in the birefringence, wherein the angle between the slow axis of the first region and the slow axis of the second region is at least 45 degrees.

28. A method for producing a polarizer, comprising:
stretching the entire film containing a cellulose acylate in a direction oblique to the film traveling direction by about 45 degrees,
heating the stretched film in such a manner that the slow axis formed by the stretching could rotate by at least 45 degrees relative to the stripe region of a part of the stretched film of which the long side is in the film conveying direction, thereby forming at least two regions of a first stripe region which has been heated such that the slow axis therein formed by stretching is rotated by at least 45 degrees and a second stripe region which has not been heated such that the slow axis therein formed by stretching is rotated by at least 45 degrees, and
laminating the resulting optical film on a long polarizer of which the transmission axis is at the width direction thereof, in a mode of roll-to-roll lamination.
